(19) United States
(12) Patent Application Publication
(10) Pub. No.: US 2019/0196766 A1
(43) Pub. Date: Jun. 27, 2019

(54) PREVIEW DISPLAY APPARATUS, MULTIFUNCTION PERIPHERAL, AND PREVIEW DISPLAY METHOD

(71) Applicant: SHARP KABUSHIKI KAISHA, Sakai City (JP)

(72) Inventor: KUNIHISA CHIBA, Sakai City (JP)

(21) Appl. No.: 16/231,411

(22) Filed: Dec. 22, 2018

(30) Foreign Application Priority Data
Dec. 26, 2017 (JP) 2017-249335

(51) Int. Cl. G06F 3/12; H04N 1/00

(52) U.S. Cl. CPC G06F 3/1256; H04N 1/00411; H04N 1/0044; G06F 3/1208

(57) ABSTRACT

A preview display apparatus includes an evaluation-value acquisition unit that acquires an evaluation value for each of a plurality of pages in accordance with a predetermined purpose, the plurality of pages being to be previewed, a page-priority adjustment unit that adjusts a priority of each of the plurality of pages in accordance with the evaluation value for the page, and a preview display unit that displays a preview image of each of the plurality of pages in accordance with the priority of the page adjusted by the page-priority adjustment unit.

### BACKGROUND

### 1. Field

The present disclosure relates to a preview display apparatus, a multifunction peripheral having the preview display apparatus, and a preview display method.

### 2. Description of the Related Art

When a print job is performed on a multifunction peripheral, text characters on a printed material are sometimes too small to read. Such a situation arises when text characters used in the original document layout are excessively small or the size of a sheet used for printing is excessively small.

To cope with such an illegibility issue due to excessively small text characters on a printed material, previewing has been proposed to check the size of the text characters before printing. For example, Japanese Unexamined Patent Application Publication No. 2009-116734 discloses a method for visual inspection or the like of preview images when content includes text characters smaller than the smallest text size that has been set. However, since the preview order is not determined in consideration of the illegibility level of each page, a user has to search for the most problematic page before displaying the most problematic page, and it takes time to determine whether to perform printing without changing the settings. This situation is aggravated when a large number of pages are to be printed.

Japanese Unexamined Patent Application Publication No. 2010-149316 discloses a method for displaying enlarged individual images of a plurality of preview images obtained by dividing a single page so as to enable a user to recognize print data content. However, when a plurality of pages are to be previewed, the issue that a user has to search for the most problematic page before displaying the most problematic page and that it takes time to determine whether to perform printing without changing the settings persists.

Thus, it is desirable to provide a preview display apparatus, a multifunction peripheral, and a preview display method that enable a user to find at an early stage a situation in which a print lob, if performed, produces an undesirable print output.

### SUMMARY

According to an aspect of the present disclosure, there is provided a preview display apparatus including an evaluation-value acquisition unit that acquires an evaluation value for each of a plurality of pages in accordance with a predetermined purpose, the plurality of pages being to be previewed, a page-priority adjustment unit that adjusts a priority of each of the plurality of pages in accordance with the evaluation value for the page, and a preview display unit that displays a preview image of each of the plurality of pages in accordance with the priority of the page adjusted by the page-priority adjustment unit.

According to another aspect of the present disclosure, there is provided a multifunction peripheral including the aforementioned preview display apparatus.

According to another aspect of the present disclosure, there is provided an information processing apparatus including the aforementioned preview display apparatus.

Further, according to another aspect of the present disclosure, there is provided a preview display method including acquiring an evaluation value for each of a plurality of pages in accordance with a predetermined purpose, the plurality of pages being to be previewed, adjusting a priority of each of the plurality of pages in accordance with the evaluation value for the page, and displaying a preview image of each of the plurality of pages in accordance with the priority of the page adjusted by the adjusting of the priority of each of the plurality of pages.

Further, according to another aspect of the present disclosure, there is provided a non-transitory computer-readable medium storing a preview display program causing a computer to function as the preview display apparatus.

### BRIEF DESCRIPTION OF THE DRAWINGS

FIG. 1 is a flowchart for illustrating a first method and a second method for performing processing from previewing to printing according to a first embodiment;

FIG. 2 is another flowchart for illustrating the first method for performing processing from previewing to printing according to the first embodiment;

FIG. 3 is another flowchart for illustrating the second method for performing processing from previewing to printing according to the first embodiment;

FIG. 4 is a flowchart for illustrating a method for determining the priority of a page according to the first embodiment;

FIG. 5A illustrates an example set of document pages to which a preview display method according to the first embodiment of the present disclosure is applied, and FIG. 5B illustrates the order of the document pages to preview in accordance with the preview display method;

FIG. 6 is a flowchart for illustrating a method for determining the priority of a page according to a second embodiment;

FIG. 7A illustrates an example set of document pages to which a preview display method according to the second embodiment of the present disclosure is applied, and FIG. 7B illustrates the order of the document pages to preview in accordance with the preview display method;

FIG. 8 is a flowchart for illustrating a method for determining the priority of a page according to a third embodiment;

FIG. 9A illustrates an example set of document pages to which a preview display method according to the third embodiment of the present disclosure is applied, and FIG. 9B illustrates the order of the document pages to preview in accordance with the preview display method;

FIG. 10 is a flowchart for illustrating a method for determining the priority of a page according to a fourth embodiment and a fifth embodiment;

FIG. 11A illustrates an example set of document pages to which a preview display method according to the fourth embodiment of the present disclosure as applied, and FIG. 11B illustrates the order of the document pages to preview in accordance with the preview display method;

FIG. 12A illustrates an example set of document pages to which a preview display method according to the fifth embodiment of the present disclosure is applied, and FIGS. 12B and 12C illustrate the orders of the document pages to preview in accordance with the preview display method;

FIG. 13 is a flowchart for illustrating a method for determining the priority of a page according to a sixth embodiment;

FIG. 14A illustrates an example set of document pages to which a preview display method according to the sixth embodiment of the present disclosure is applied, and FIG. 14B illustrates the order of the document pages to preview in accordance with the preview display method;

FIG. 15 is a flowchart for illustrating a method for determining the priority of a page according to a seventh embodiment;

FIG. 16A illustrates an example set of document pages to which a preview display method according to the seventh embodiment of the present disclosure is applied, and FIG. 16B illustrates the order of the document pages to preview in accordance with the preview display method;

FIG. 17 is a flowchart for illustrating a method for determining the priority of a page according to an eighth embodiment;

FIG. 18A illustrates an example set of document pages to which a preview display method according to the eighth embodiment of the present disclosure is applied, and FIG. 18B illustrates the order of the document pages to preview in accordance with the preview display method;

FIG. 19A illustrates an example set of document pages to which a preview display method according to a ninth embodiment of the present disclosure is applied, and FIG. 19B illustrates the order of the document pages to preview in accordance with the preview display method;

FIG. 20 is a block diagram illustrating a configuration of a preview display apparatus according to an eleventh embodiment;

FIG. 21 illustrates a home screen displayed in the first embodiment of the present disclosure;

FIG. 22 illustrates an initial screen for copying displayed in the first embodiment of the present disclosure;

FIG. 23 illustrates a preview screen normally displayed in the first embodiment of the present disclosure;

FIG. 24 illustrates a preview screen with a pop-up dialog box displayed when a document includes a page having many small text characters in the first embodiment of the present disclosure;

FIG. 25 illustrates a preview screen displayed when “Yes” is selected on the dialog box in FIG. 24 and other figures in the first embodiment of the present disclosure;

FIG. 26 illustrates a screen for setting a copy ratio displayed when a selection button denoted by “Change Copy Ratio for This Page” is touched on the screen in FIG. 25 in the first embodiment of the present disclosure;

FIG. 27 illustrates a screen for setting a sheet size displayed when a selection button denoted by “Change Sheet Size for This Page” is touched on the screen in FIG. 25 in the first embodiment of the present disclosure;

FIG. 28 illustrates a preview screen with a pop-up dialog box displayed when a document includes a page with a high blank portion ratio in the second embodiment of the present disclosure;

FIG. 29 illustrates a preview screen with a pop-up dialog box displayed when a document includes a page with a high blank portion ratio at the top of a page in the third embodiment of the present disclosure;

FIG. 30 illustrates a preview screen with a pop-up dialog box displayed when a document includes a page having a small color area in the fourth embodiment of the present disclosure;

FIG. 31 illustrates a preview screen with a pop-up dialog box displayed when a document includes a page with a keyword in the sixth embodiment of the present disclosure;

FIG. 32 illustrates a preview screen with a pop-up dialog box displayed when a document includes a page for which the ratio of the total image area in the page to the total page area is equal to a predetermined value or larger in the seventh embodiment of the present disclosure;

FIG. 33 illustrates a preview screen with a pop-up dialog box displayed when a document includes a page for which the ratio of the total table area in the page to the total page area is equal to a predetermined value or larger in the eighth embodiment of the present disclosure;

FIG. 34 illustrates a preview screen with a pop-up dialog box displayed when a document includes a page subjected to a background removal processing in the ninth embodiment of the present disclosure;

FIG. 35 is a conceptual cross sectional view of a multifunction peripheral according to a twelfth embodiment of the present disclosure; and

FIG. 36 is a functional block diagram of the multifunction peripheral according to the twelfth embodiment of the present disclosure.

### DESCRIPTION OF THE EMBODIMENTS

Hereinafter, embodiments of the present disclosure will be described in detail with reference to the drawings.

### First Embodiment

According to a first embodiment of the present disclosure, a page having text characters whose printed-text size is excessively small can be found at an early stage. To achieve this goal, generally speaking, as the printed-text size of text characters included on a page decreases, the assigned priority of the page in previewing increases. Then, each page is previewed in order of priority. In this way, a page having text characters whose printed-text size is excessively small is found at an early stage, and consequently a user is able to perform at an early stage, for example, operation to change settings to increase the magnification or reduction ratio for printing.

For example, in a method of the related art, when a document is printed from the first page to the tenth page and the settings are to be changed to increase the magnification or reduction ratio for the tenth page, which is the last page, because of excessively small text characters on the tenth page, the user has to view the preview images of ten pages to find the text size that is too small on the tenth page. In contrast, according to this embodiment, since the tenth page is previewed first, the user views a preview screen for only a single page to find the text size that is too small on the tenth page. As the number of pages to print increases, the difference between the two cases increases.

In addition, pages are previewed in order of increasing text size. Thus, once the user is able to verify that text characters on a previewed page are not too small, the user is able to deduce that text characters on pages following the previewed page are not too small either. Consequently, the user has to view no further preview screen to check the text size.

In addition to the page content, the page number is also displayed on the preview display screen. Accordingly, the user is able to visually determine which page is to be magnified.

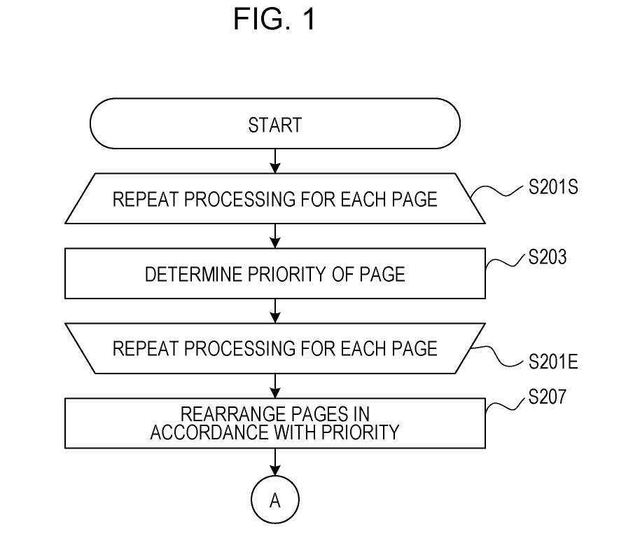

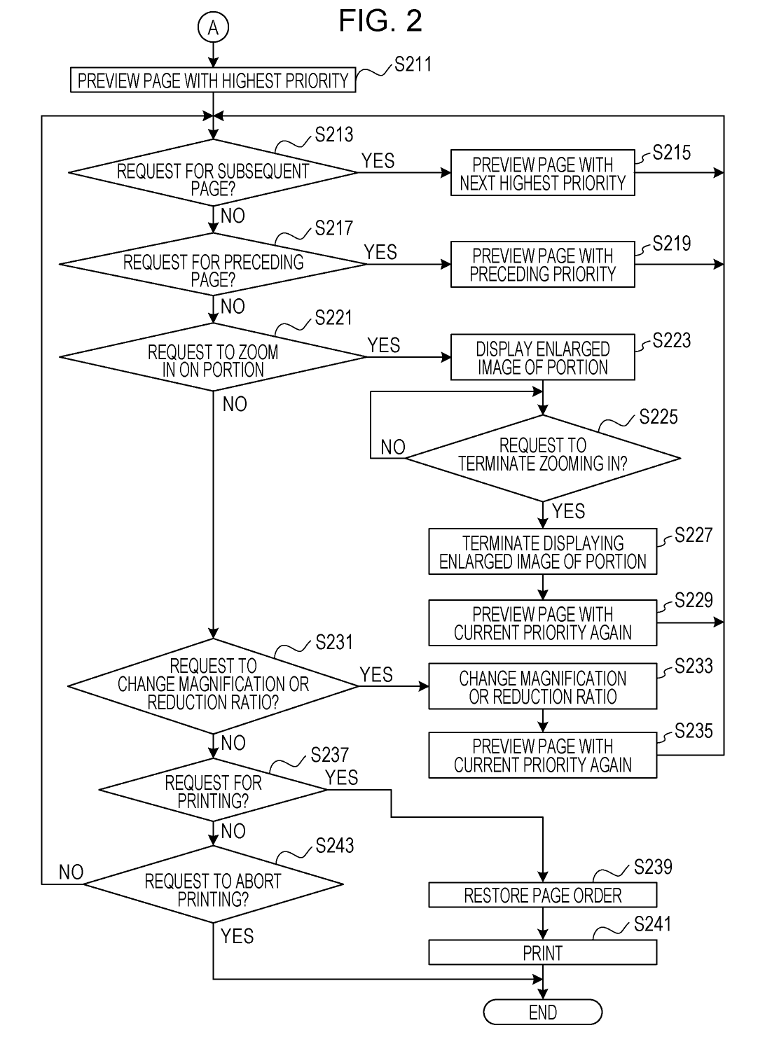

FIGS. 1 and 2 are flowcharts for illustrating a method for performing processing from previewing to printing according to the first embodiment.

Referring to FIG. 1, the priority of each page is determined by repeating processing from step S201S to step S201E for each page (step S203).

When the repetition finishes, the pages are rearranged in accordance with priority (step S207). Specifically, the pages are rearranged in order of priority.

Referring to FIG. 2, the page with the highest priority is subsequently previewed (step S211).

Then, if a request for the subsequent page is received (YES in step S213), the page with the next highest priority is previewed (step S215), and the process returns to step S213. If no subsequent page exists, the process bypasses step S215 and returns to step S213.

If a request for the preceding page is received (YES in step S217), the page with the preceding priority is previewed (step S219), and the process returns to step S213. If no preceding page exists, the process bypasses step S219 and returns to step S213.

If a request to zoom in on a portion of a page is received (YES in step S221), an enlarged image of the portion is displayed (step S223). While the enlarged image of the portion is being displayed, if a request to terminate zooming in is received (step S225), displaying the enlarged image of the portion is terminated (step S227), and the page with the current priority is previewed again (step S229). Then, the process returns to step S213.

In step S223, an enlarged image of a portion of a previewed page can be displayed. Accordingly, for example, when a user is not able to determine whether to change the magnification or reduction ratio for a page by only viewing a normal preview image of the page, the user applies step S223 to a portion whose enlarged image on the preview screen enables the user to determine whether to change the magnification or reduction ratio for the page, and consequently the user can actually determine whether to change the magnification or reduction ratio.

If a request to change the magnification or reduction ratio is received (YES in step S231), the magnification or reduction ratio for the page with the current priority is changed (step S233), and the page with the current priority is previewed again (step S235).

If printing is requested (YES in step S237), the page order before performing step S207 is restored (step S239), and printing is performed (step S241). Step S239 may be omitted. In addition, after step S237, the user may be asked whether only the current page is to be printed. If the reply is YES, only the current page may be printed, and the process may return to step S213 thereafter.

If a request to abort printing is received (YES in step S243), printing is aborted.

If no request to abort printing is received (NO in step S243), the process returns to step S213.

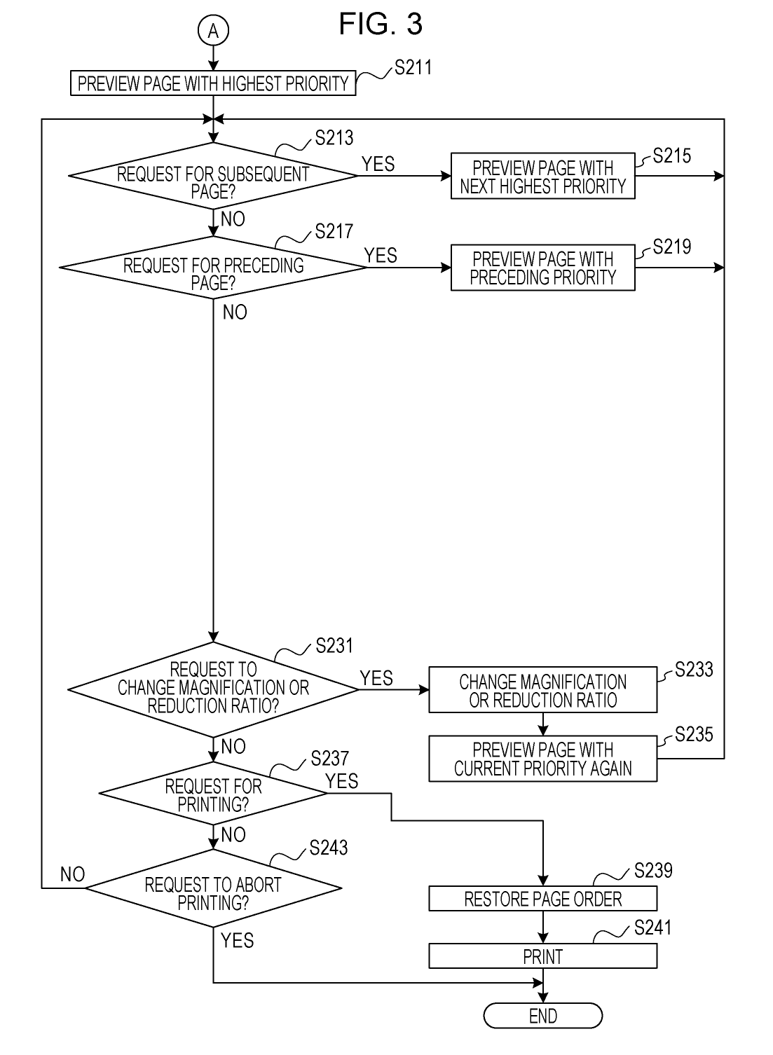

The function of zooming in on a portion of a page may be omitted. In such a case, steps S221, S223, S225, S227 and S229 of the flowchart in FIG. 2 are omitted from the flowchart in FIG. 3.

Next, step S203, in which the priority of a page is determined, will be described in detail.

For example, the size of the smallest text character included on a page may be used as the text size for determining the priority.

Alternatively, the text size for determining the priority may be determined as follows.

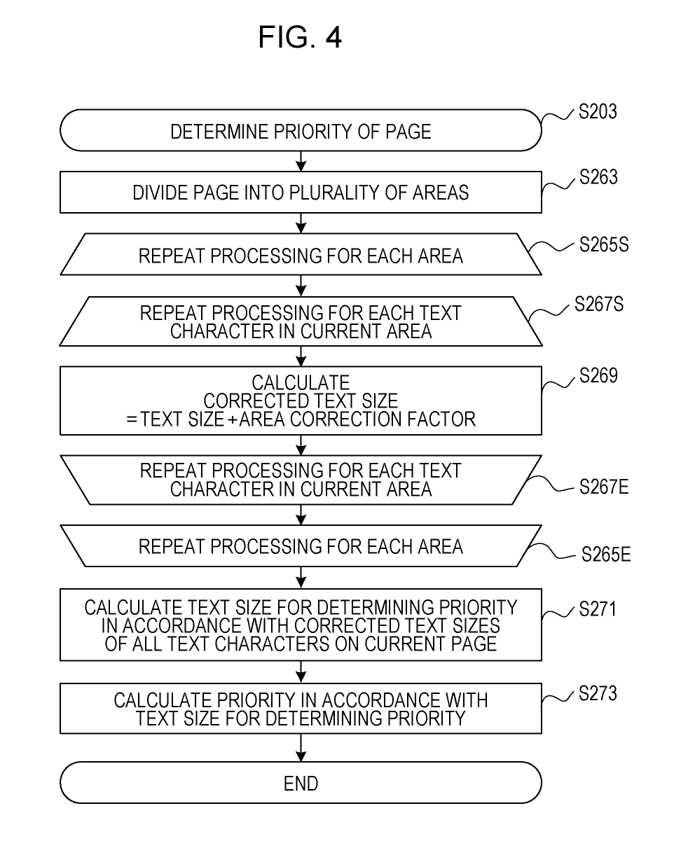

As illustrated in FIG. 4, a page is divided into a plurality of areas (step S263). Examples of such areas are three regions, which are the header, the footer, and the body. Step S263 may be omitted for a certain page, and a page may have only one area, which is the body.

Next, a corrected text size is calculated for each of the text characters in each area (from step S267S to step S267E) by using the following equation (step S269):

corrected text size=text size+area correction factor (1).

The same calculation is repeated for all the areas of a page (from step S265S to S265E). Each area generally has a different area correction factor. For example, the area correction factor is set to zero for the body area and to a predetermined positive value for each of the header area and the footer area. In this way, if a page has a header area and a footer area whose text sizes are smaller than the text size in the body area, such a page can be dealt with appropriately.

Next, the text size far determining the priority of a page is calculated in accordance with the corrected text sizes of all the text characters on the page (step S271).

The text size for determining the priority is a text size used to determine the priority and may be the actual text size, the corrected text size, or a text size determined by using a predetermined method in accordance with any of the actual or corrected text sizes.

For example, the corrected text size of each text character included on a page may be compared with the corrected text size of other text characters included on the page, and the smallest size among the corrected text sizes may be selected as the text size for determining the priority of the page.

Alternatively, for example, a weighted average of corrected text sizes over an entire page may be selected as the text size for determining the priority. As an overall tendency, the weighting factor may increase as the corrected text size decreases or may be equal to zero for the corrected text size equal to or above a predetermined value and equal to a fixed value or dependent on the corrected text size for the corrected text size below the predetermined value.

Next, the priority of a page is calculated in accordance with the text size for determining the priority of the page (step S273). Specifically, if a rule specifies that a larger value indicates a higher priority, the text size for determining the priority with a minus sign may be used as the priority. If a rule specifies that a smaller value indicates a higher priority, the text size for determining the priority may be used as the priority without changing.

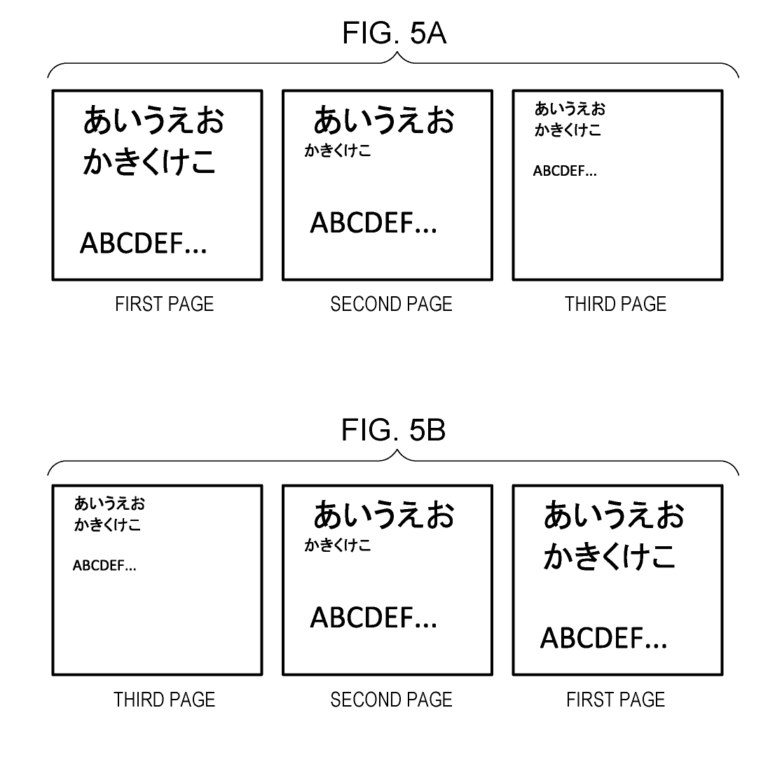

For example, as illustrated in FIG. 5A, if the page order in ascending order of corrected text size is the third page, the second page, and the first page, the preview images are displayed in this order as illustrated in FIG. 5B.

Next a description including a user interface will be provided.

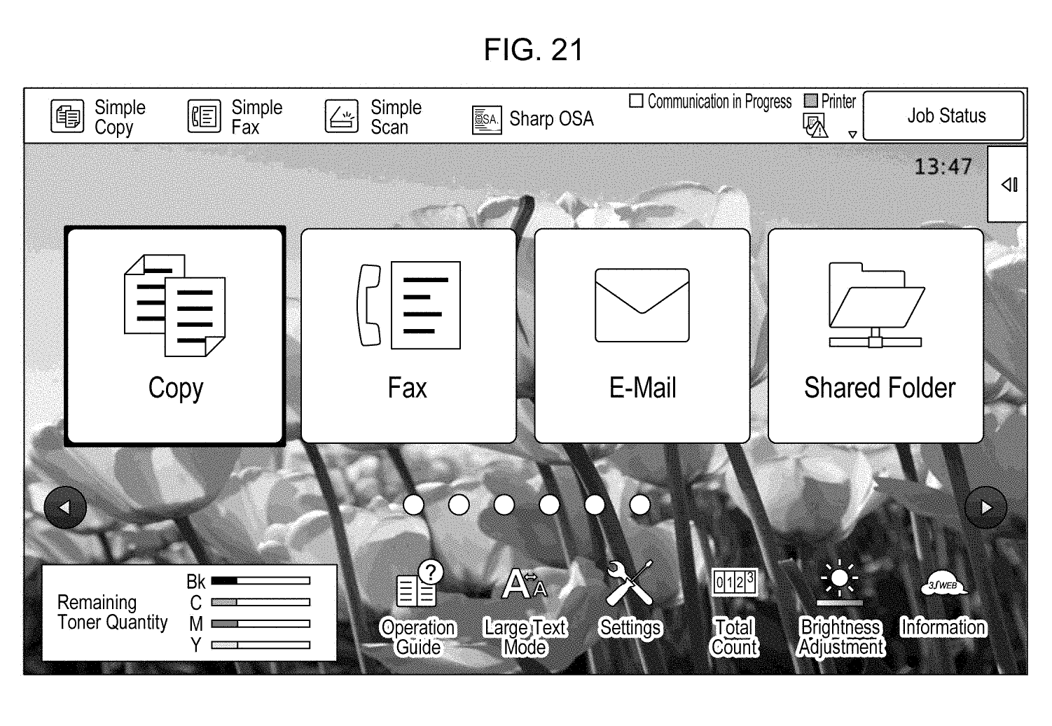

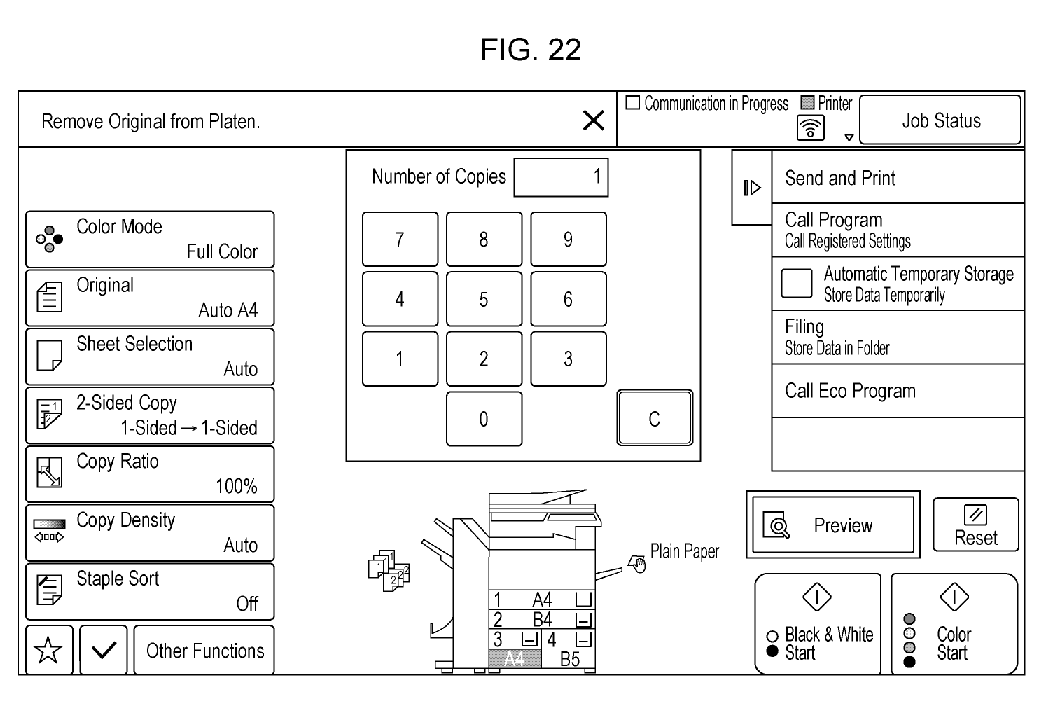

If “Copy” is selected on the home screen illustrated in FIG. 21, the initial screen for copying is displayed as illustrated in FIG. 22.

Then, while the initial screen for copying illustrated in FIG. 22 is displayed, if a user touches the preview button after setting a document having one or more pages on the automatic document feeder, a document scanner successively scans pages of the document having one or more pages.

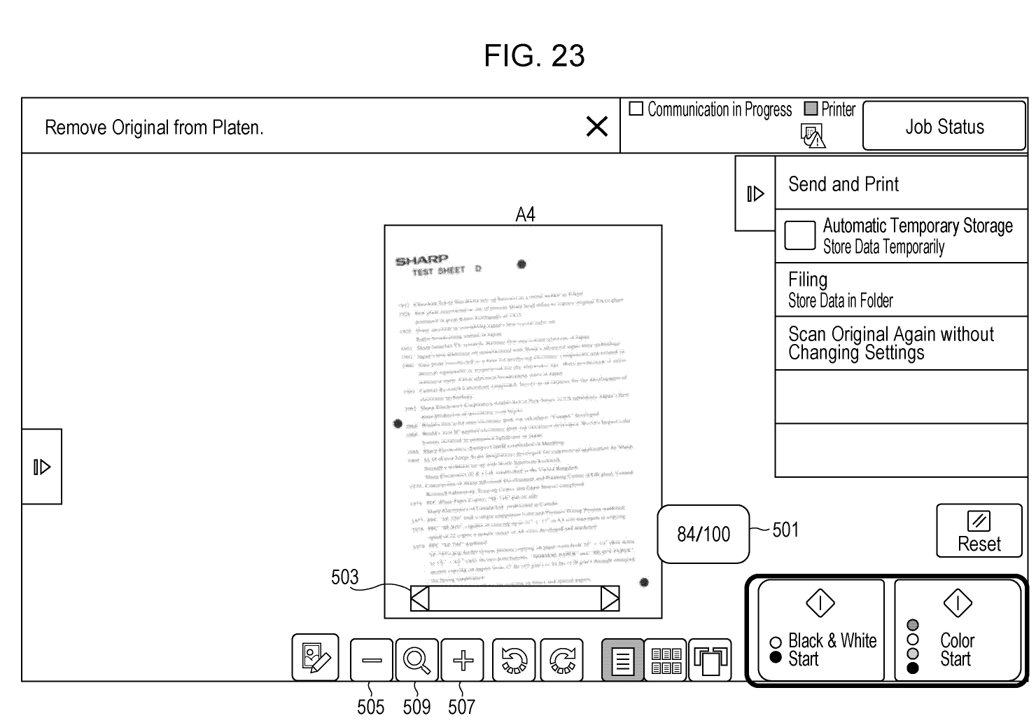

When the document scanner finishes scanning pages, a preview screen is displayed as illustrated in FIG. 23. This preview screen displays a page number 501 that indicates the position of the currently displayed page in the scanning sequence and a scroll bar 503 for switching pages to preview. This preview screen also displays buttons 505 and 507 for changing the magnification or reduction ratio for the entire preview image and a button 509 for displaying a scroll bar used to zoom in or out. Zooming in corresponds to enlarging a portion of a document. An enlarged portion of a previewed document can be moved by touching the enlarged portion with a finger and sliding the finger on the preview screen while the finger is in contact with the screen.

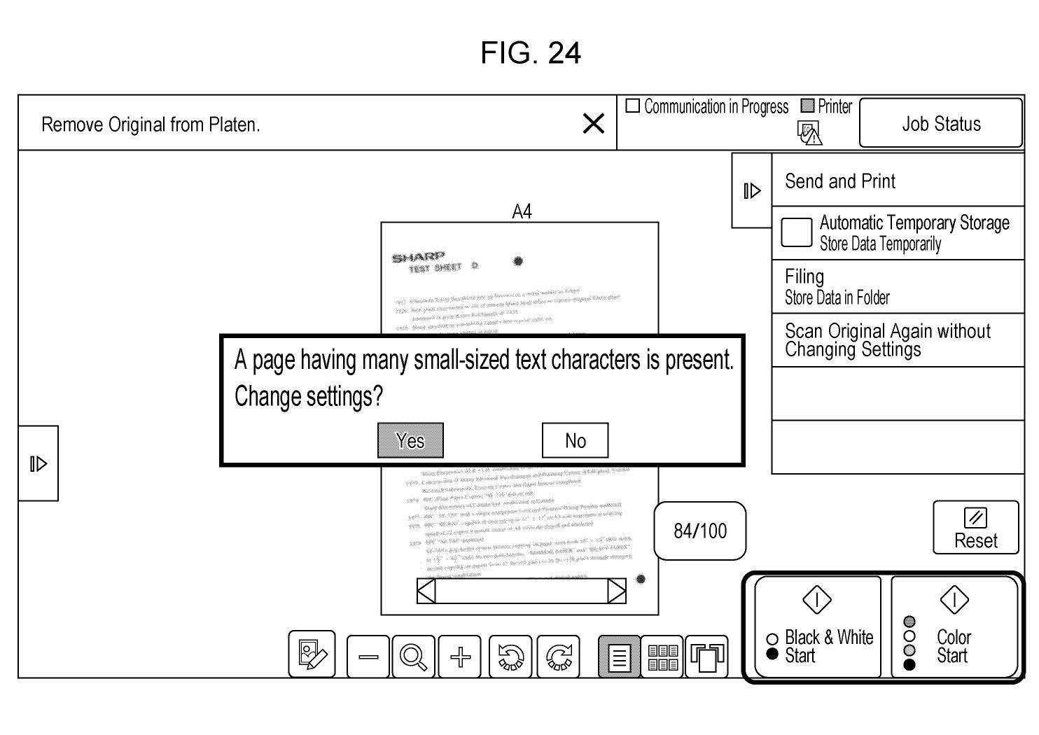

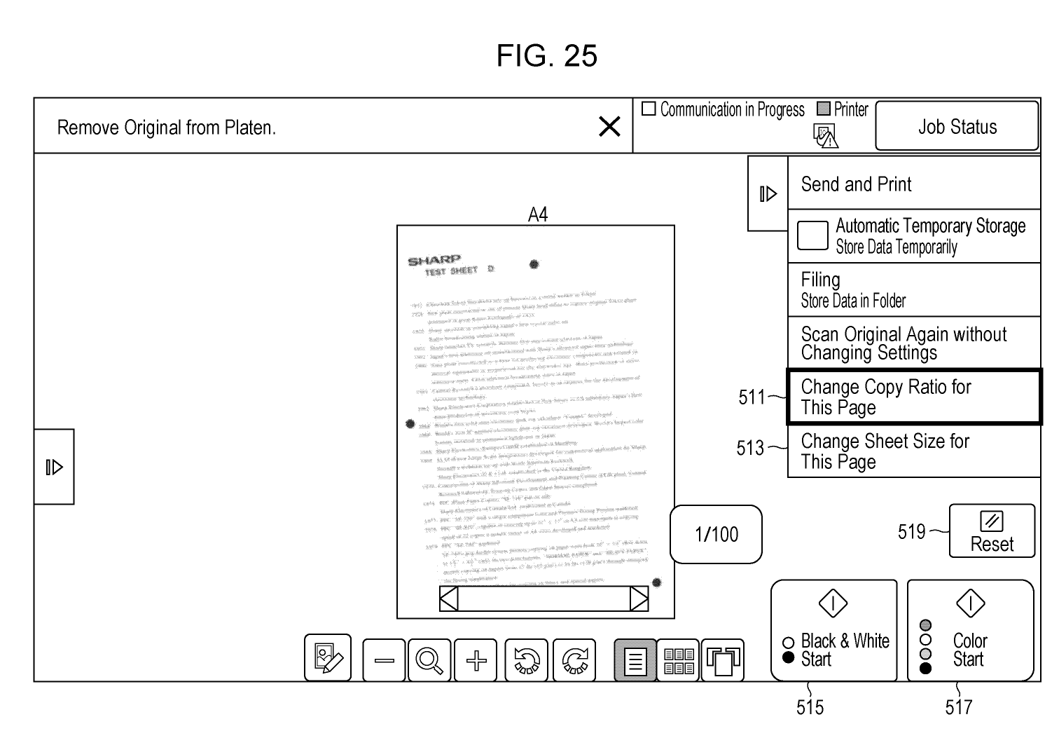

Next, each scanned page is subjected to character recognition processing, and consequently text characters included on each page and the sizes of the text characters are obtained. If it is determined by using a predetermined method that a page having small text characters is present among the scanned pages, a dialog box presenting a question “A page having many small text characters is present. Change settings?” is displayed as illustrated in FIG. 24, and if “Yes” is selected, additional buttons for transitioning to a setting change screen are displayed as illustrated in FIG. 25.

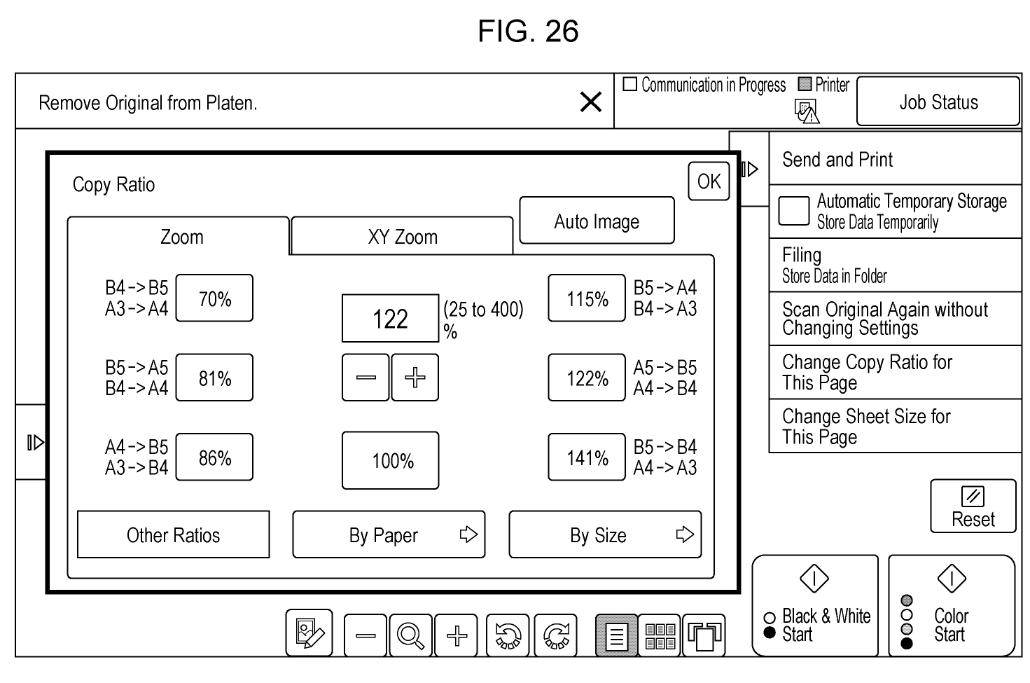

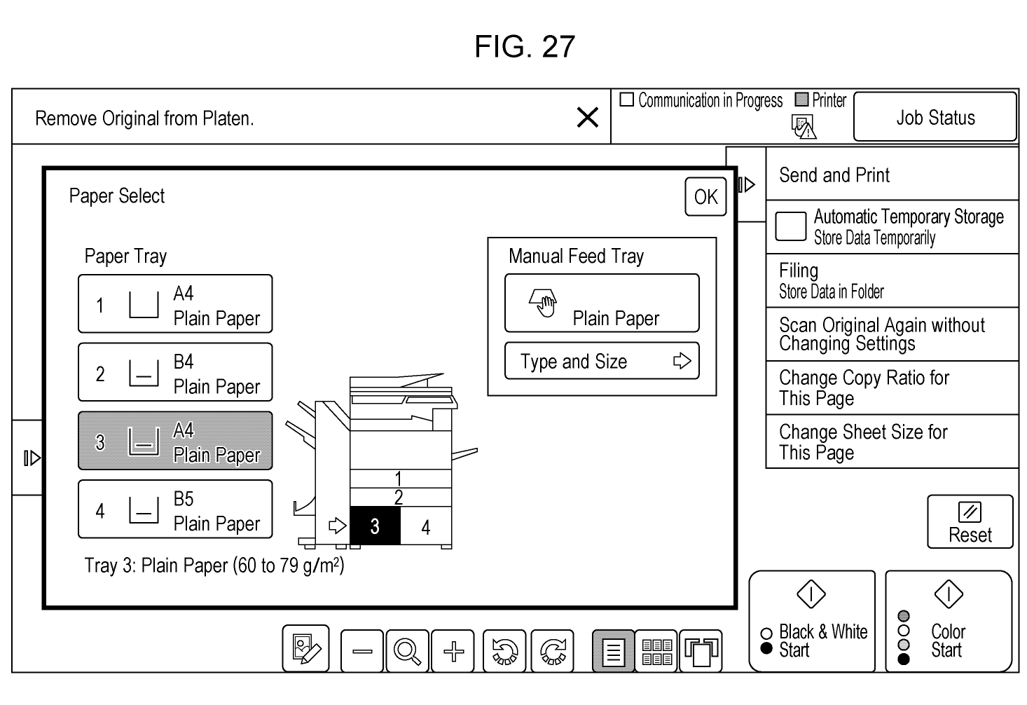

A selection button 511 to select “Change Copy Ratio for This Page” and a selection button 513 to select “Change Sheet Size for This Page” are added to the screen as illustrated in FIG. 25. If the former selection button is touched on this screen, a details setting screen as illustrated in FIG. 26 is displayed. If the latter selection button is touched, a details setting screen as illustrated in FIG. 27 is displayed.

When the copy ratio is changed and the “OK” button is touched on the details setting screen in FIG. 26, the details setting screen is closed, and the screen in FIG. 25 reappears displaying a preview image incorporating the change in the settings. Buttons 515 and 517 to start copying and a button 519 to abort copying are also displayed on the screen in FIG. 25, and a user can choose to start or abort copying. Further, the selection buttons 511 and 513 are also displayed, and a user may additionally change the copy ratio or the sheet size before starting copying.

### Second Embodiment

According to a second embodiment of the present disclosure, an occurrence of an additional page due to printing an overflowing portion of a text region (referred to as “overflow print”) can be found at an early stage. This overflow print is caused because a portion of a text region to be originally included on the same page as the other portions of the text region overflows into another page. To achieve this goal, generally speaking, as the blank portion ratio for a page increases, the assigned priority of the page in previewing increases. Then, each page is previewed in order of priority. In this way, for example, a page used for printing an overflowing portion of a spreadsheet (referred to as “overflow print page”) or a page having only a few lines in a document that overflow into another page (also referred to as “overflow print page”) is found at an early stage, and consequently a user is able to perform at an early stage, for example, operation to change settings to decrease the magnification or reduction ratio for printing.

When a spreadsheet is printed, if the magnification or reduction ratio for the spreadsheet is not adequately adjusted, an overflow print page is sometimes produced to allocate a print space to only text characters and numerals located near the right end of the spreadsheet. In addition, for example, when a letter document is printed, an overflow print page that has only a few lines is sometimes produced. Many of such pages have a high blank portion ratio, and thus previewing a page having a high blank portion ratio at an early stage enables a user to check the contents of such a page at an early stage and to change settings to decrease the magnification or reduction ratio accordingly or abort printing.

For example, in a case where a file having ten spreadsheets has an overflow on the tenth spreadsheet, each page from the first spreadsheet to the tenth spreadsheet is to be previewed before the overflow is found if a method of the related art is used. However, according to this embodiment, a user is able to find the overflow by displaying only a preview image of a page allocated for printing an overflowing portion of the tenth spreadsheet.

A method of processing from previewing to printing according to the second embodiment is the same as or similar to the method according to the first embodiment illustrated in FIG. 1 and FIG. 2 or 3, and thus a duplicate description will be omitted.

Next, step S203, in which the priority of a page is determined, will be described in detail.

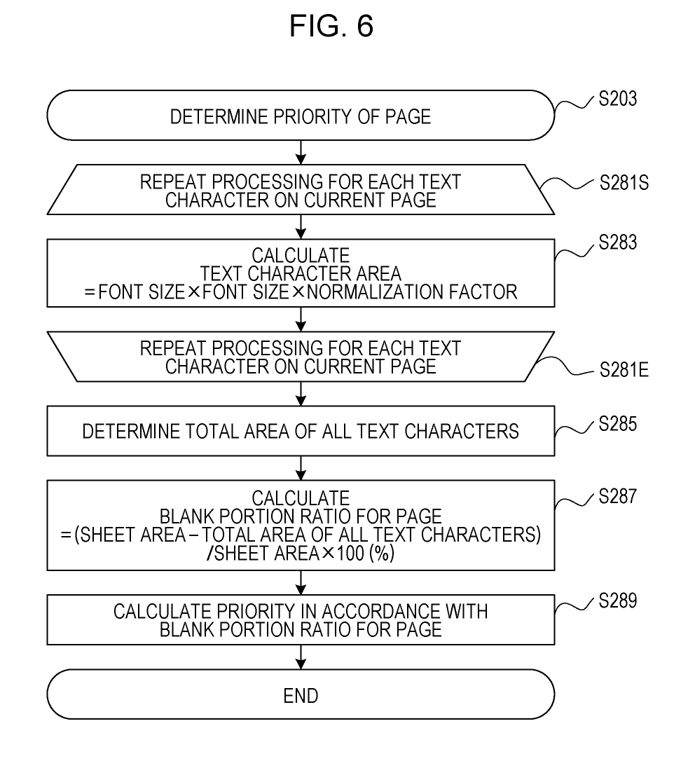

As illustrated in FIG. 6, for each text character on a page, a text character area is calculated as follows (steps S281S, S283, and S281E):

text character area=font size×font size×normalization factor (2).

Here, the normalization factor is the reciprocal of the area of a text character of one point in size.

Next, the total area of all the text characters on a page is calculated in accordance with the area of each of all the text characters included on the page (step S285).

Then, the blank portion ratio for the page is calculated as follows (step S287):

blank portion ratio for a page=(sheet area−total area of all the text characters)/sheet area×100(%) (3).

Next the priority of a page is calculated in accordance with the blank portion ratio for the page (step S289). If a rule is specified that a larger value indicates a higher priority, the blank portion ratio for the page may be used as the priority without changing. If a rule is specified that a smaller value indicates a higher priority, (total area of all the text characters)/(sheet area) may be used as the priority.

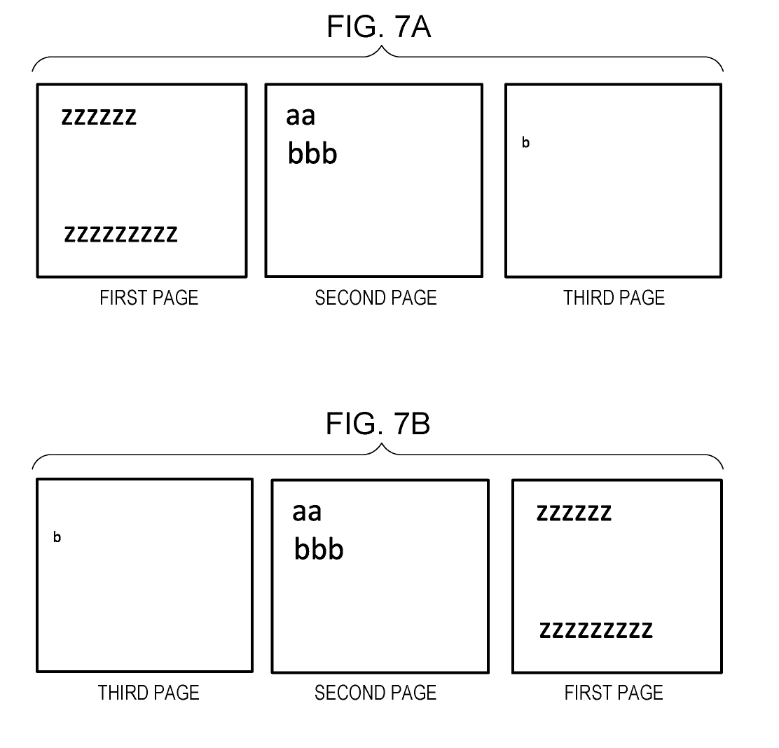

For example, as illustrated in FIG. 7A, if the page order in descending order of blank portion ratio for a page is the third page, the second page, and the first page, the preview images are displayed in this order as illustrated in FIG. 7B.

The user interface according to the second embodiment is the same as or similar to the user interface according to the first embodiment.

However, in the first embodiment, each scanned page is subjected to character recognition processing, and consequently text characters included on each page and the sizes of the text characters are obtained. If it is determined by using the method illustrated in FIG. 4 that a page having small text characters is present among the scanned pages, a dialog box presenting a question “A page having many small text characters is present. Change settings?” is displayed as illustrated in FIG. 24, and if “Yes” is selected, additional buttons for transitioning to the setting change screen are displayed as illustrated in FIG. 25.

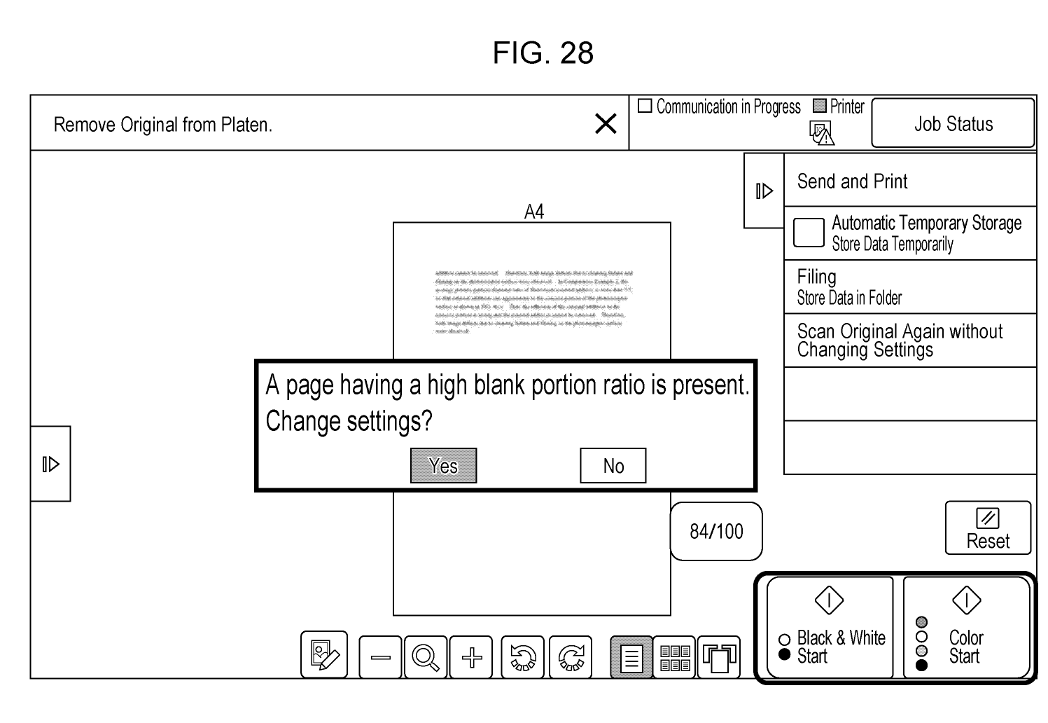

In the second embodiment, each scanned page is subjected to character recognition processing, and consequently text characters included on each page and the sizes of the text characters are obtained. In contrast to the first embodiment, calculations based on Equations 2 and 3 are performed by using the text characters and the sizes thereof, and if it is determined that a page having the blank portion ratio higher than a predetermined value is present among the scanned pages, a dialog box presenting a question “A page having a high blank portion ratio is present. Change settings?” is displayed as illustrated in FIG. 28. If “Yes” is selected, additional buttons for transitioning to the setting change screen are displayed as illustrated in FIG. 25.

### Third Embodiment

According to a third embodiment of the present disclosure, for the second section or a subsequent section in a document, if the top of a section does not coincide with the top of a page and the section begins at a position several lines behind the top of the page, such a situation can be found at an early stage. To achieve this goal, generally speaking, for a page having a blank at the top of the page, as the blank portion ratio of the page increases, the assigned priority of the page in previewing increases. Then, each page is previewed in order of priority.

In a normal operation, when a section break is placed on a document, the section break triggers a page break, and the document content following the section break is from the top of a new page. The document content following the section break sometimes begins at an intermediate position on a page against the intention of a user.

The preview display described above enables the user, for example, to find at an early stage a page for which document content following a section break begins at an intermediate position on a new page and, for example, to reduce the time that it takes to abort printing and start re-editing the document. For example, in a case where a document has ten sections and only the tenth section does not begin at the top of a page, each page from the first page of the first section to the first page of the tenth section has to be successively previewed before the blank at the top of a page is found if a method of the related art is used. However, according to this embodiment, the first page of the tenth section is previewed first, and thus a user is able to find that the top of the tenth section does not coincide with the top of a page viewing a preview image of only one page.

A method of processing from previewing to printing according to the third embodiment is the same as or similar to the method according to the first embodiment illustrated in FIG. 1 and FIG. 2 or 3, and thus a duplicate description will be omitted.

Next, step S203, in which the priority of a page is determined, will be described in detail.

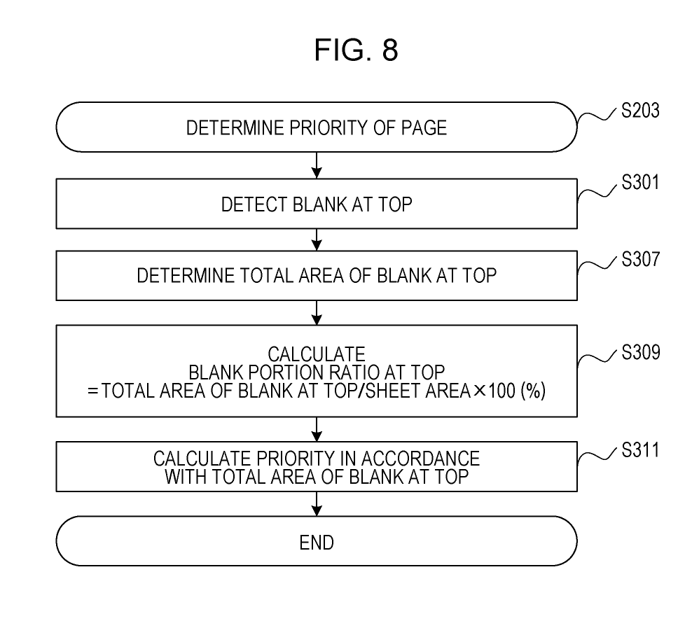

As illustrated in FIG. 8, a blank at the top of a page is detected first (step S301). For example, consecutive lines that have no printed text character and are located at the top of a page are detected.

Next, the total area of a blank at the top is determined in accordance with a height of each line (in the case of horizontal writing), a width of each line (in the case of vertical writing) or the like in a blank at the top (step S307).

Steps S301 and S307 may be performed using image data of a print image (such as bitmap data).

Then, the blank portion ratio at the top is calculated as follows (step S309):

blank portion ratio at the top=total area of a blank at the top/sheet area×100(%) (4).

Next, the priority of a page is calculated in accordance with the total area of a blank at the top (step S311). Specifically, the assigned priority increases as the blank portion ratio at the top increases. If a rule is specified that a larger value indicates a higher priority, the blank portion ratio at the top may be used as the priority without changing. If a rule is specified that a smaller value indicates a higher priority, the blank portion ratio at the top with a minus sign may be used as the priority.

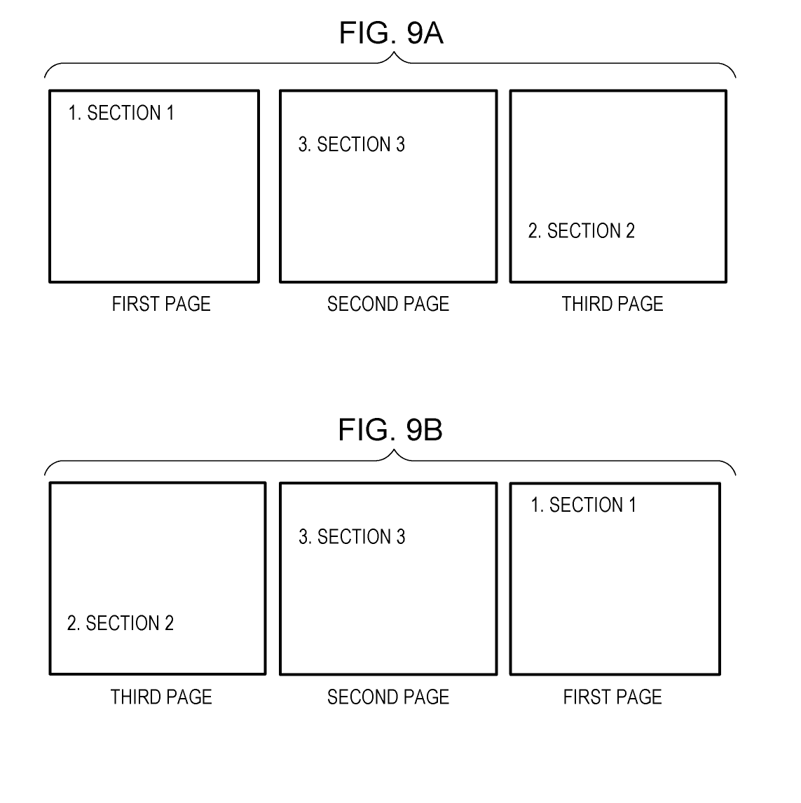

For example, as illustrated in FIG. 9A, if the page order in descending order of blank portion ratio at the top is the third page, the second page, and the first page, the preview images are displayed in this order as illustrated in FIG. 9B.

The user interface according to the third embodiment is the same as or similar to the user interface according to the first embodiment.

However, in the first embodiment, each scanned page is subjected to character recognition processing, and consequently text characters included on each page and the sizes of the text characters are obtained. If it is determined by using a predetermined method that a page having small text characters is present among the scanned pages, a dialog box presenting a question “A page having many small text characters is present. Change settings?” is displayed as illustrated in FIG. 24, and if “Yes” is selected, additional buttons for transitioning to the setting change screen are displayed as illustrated in FIG. 25.

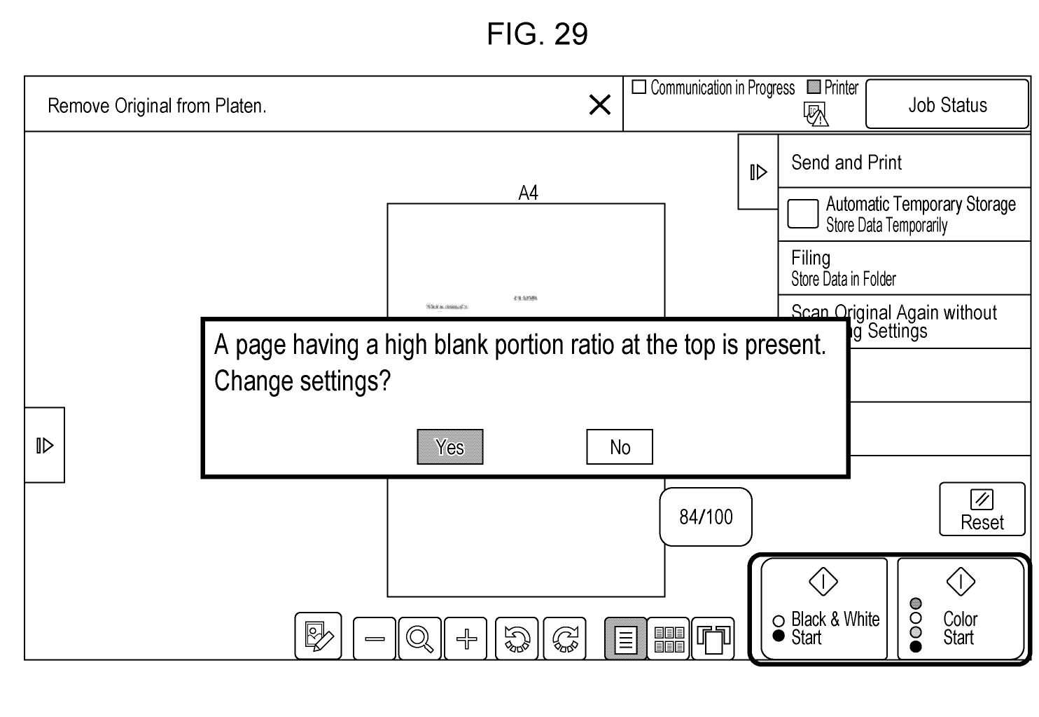

In contrast, in the third embodiment, the total area of a blank at the top of each scanned page is obtained. Calculations based on Equations 4 and 3 are performed in the method illustrated in FIG. 8, and if it is determined that a page having the blank portion ratio at the top higher than a predetermined value is present among the scanned pages, a dialog box presenting a question “A page having a high blank portion ratio at the top present. Change settings?” is displayed as illustrated in FIG. 29. If “Yes” is selected, additional buttons for transitioning to the setting change screen are displayed as illustrated in FIG. 25.

### Fourth Embodiment

According to a fourth embodiment of the present disclosure, for a document that has a color portion and that is to be printed in color, if a user selects grayscale printing without recognizing that the document has a color portion, such a situation can be found at an early stage. To achieve this goal, a page having a color portion is prioritized in previewing in color. In particular, if a color portion is small, such a mistake is likely to occur through oversight, and thus a page having a smaller color portion among pages having a color portion is prioritized in previewing.

A method of processing from previewing to printing according to the fourth embodiment is the same as or similar to the method according to the first embodiment illustrated in FIG. 1 and FIG. 2 or 3, and thus a duplicate description will be omitted.

Next, step S203, in which the priority of a page is determined, will be described in detail.

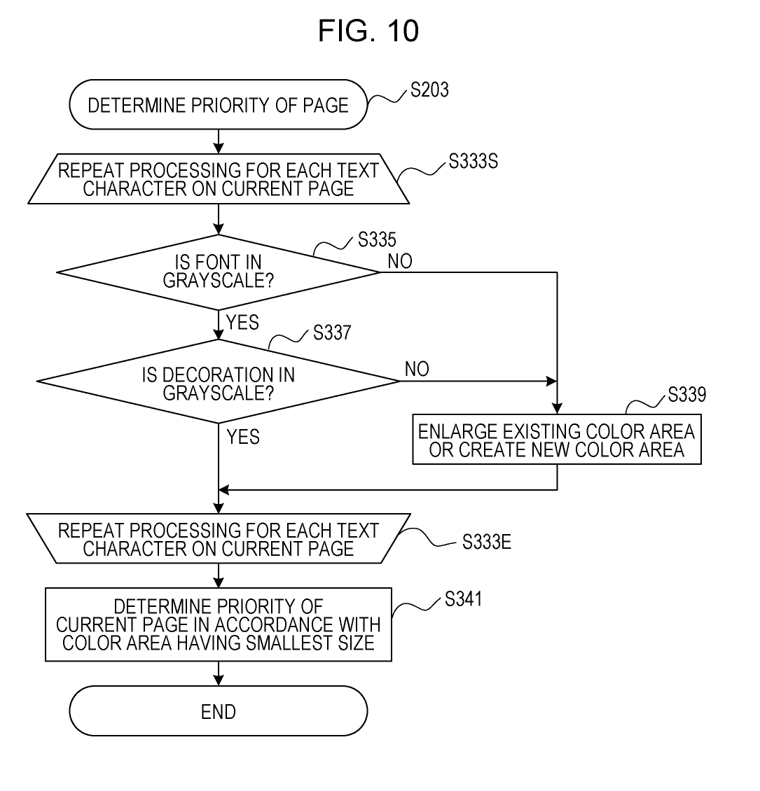

As illustrated in FIG. 10, for each text character on a page, processing from step S333S to step S333E is repeated.

In this repetition, if the font of a text character is not in grayscale (NO in step S335) or the decoration of a text character is not in grayscale (NO in step S337), a new color area is created, or one of the existing color areas is enlarged (step S339).

A color area is defined as an area in which one or more text characters each of which has the font or decoration not in grayscale are continuously arranged. If a newly found text character whose font or decoration is not in grayscale touches as existing color area in any direction, the existing color area is enlarged. If a newly found text character whose font or decoration is not in grayscale does not touch as existing color area, a new color area is created.

When the repetition is finished, the evaluation value for a page is determined in accordance with the color area having the smallest size of all the color areas created on the page (step S341). For example, the evaluation value is calculated as follows:

evaluation value=the size of the smallest color area/sheet size (if one or more color areas are present) (5), or

evaluation value=1(if no color area is present) (6).

Then, a rule under which a page having a smaller evaluation value is prioritized is applied.

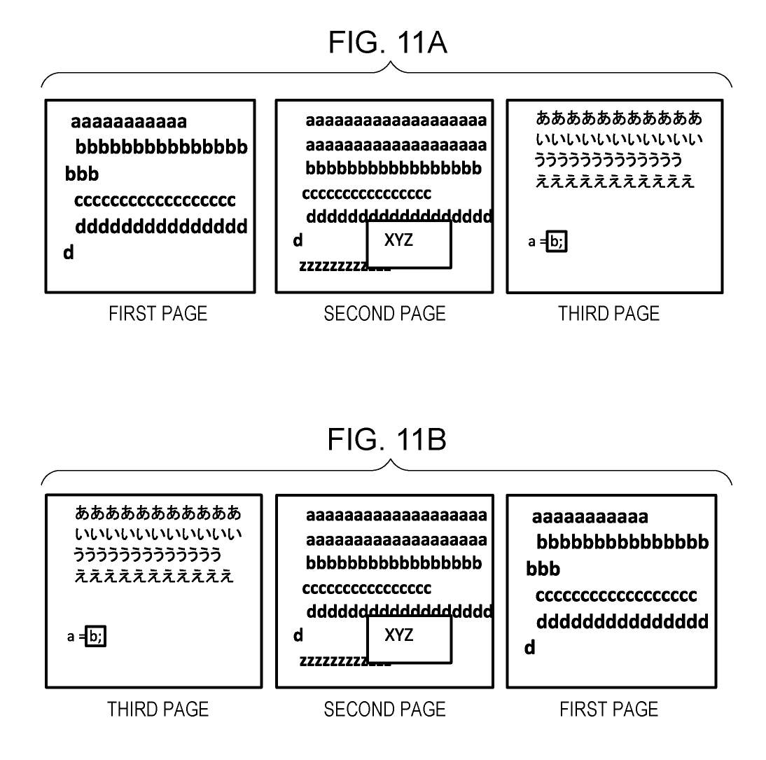

For example, as illustrated in FIG. 11A, in a case where the evaluation value for the first page having no color portion is equal to 1 and the evaluation value for the third page is smaller than the evaluation value for the second page because the third page has a color portion indicated by a frame that is smaller than a frame indicating a color portion on the second page, in other words, in a case where the evaluation value for each page decreases with the order the first, second, and third pages, previewing is performed in order of increasing evaluation value as illustrated in FIG. 11B.

The user interface according to the fourth embodiment is the same as or similar to the user interface according to the first embodiment.

However, in the first embodiment, each scanned page is subjected to character recognition processing, and consequently text characters included on each page and the sizes of the text characters are obtained. If it is determined by using a predetermined method that a page having small text characters is present among the scanned pages, a dialog box presenting a question “A page having many small text characters is present. Change settings?” is displayed as illustrated in FIG. 24, and if “Yes” is selected, additional buttons for transitioning to the setting change screen are displayed as illustrated in FIG. 25.

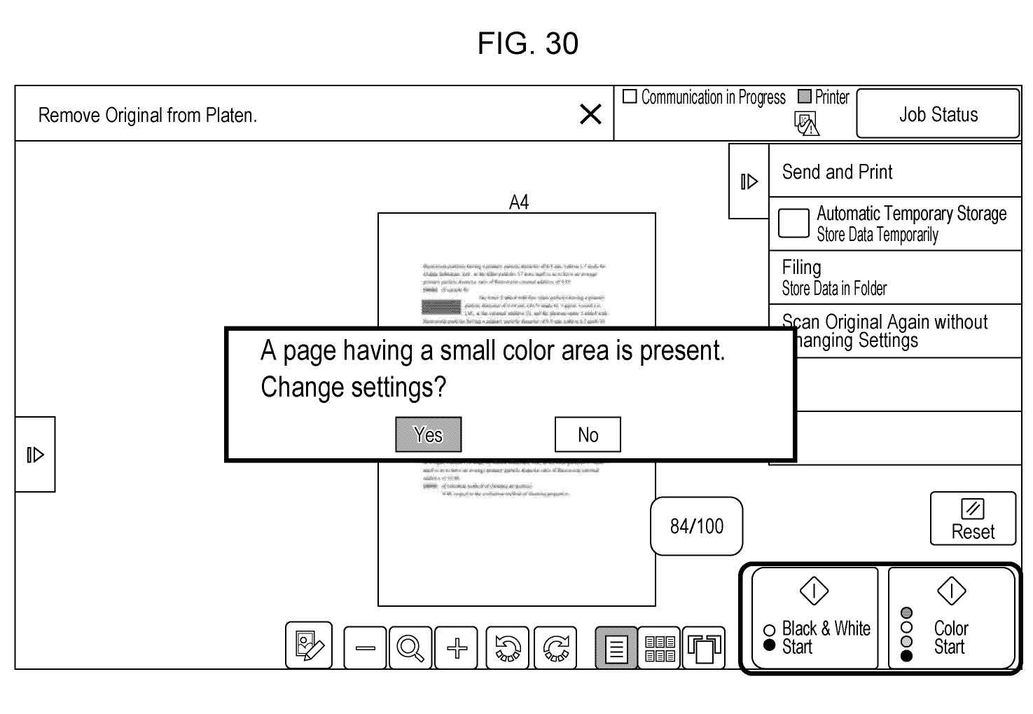

In contrast, in the fourth embodiment, the size of the smallest color area is obtained for each scanned page. Calculations based on Equations 5 and 6 are performed in the method illustrated in FIG. 10, and if it is determined that a page having the evaluation value smaller than a predetermined value is present among the scanned pages, a dialog box presenting a question “A page having a small color area is present. Change settings?” is displayed as illustrated in FIG. 30. If “Yes” is selected, additional buttons for transitioning to the setting change screen are displayed as illustrated in FIG. 25.

### Fifth Embodiment

According to a fifth embodiment of the present disclosure, similarly to the fourth embodiment, for a document that has a color portion and that is to be printed in color, if a user selects grayscale printing without recognizing that the document has a color portion, such a situation can be found at an early stage. In addition, operation that is not performed in the fourth embodiment can be performed, that is, for a document that has a color portion but that is to be printed in grayscale for cost-saving, if a user selects color printing, such a situation can be found at an early stage. To achieve this goal, a page having a color portion is prioritized in previewing, and preview images displayed in accordance with selected color modes are also placed for comparison.

Operation in this embodiment is the same as or similar to the operation in the fourth embodiment and is not repeatedly described herein.

In this embodiment, when images are displayed in steps S211, S215, S219, and S229, a preview image with colors in the document retained without changing and another preview image processed in accordance with the selected color modes are simultaneously placed. Similar operation may be performed for an enlarged image of a portion of a page in step S223. If the two preview images are compared with each other and it is found that a portion in the former preview image is presented in color and the corresponding portion in the latter preview image is presented in monochrome, it can easily be found that, for a document that has a color portion and that is to be printed in color, a user has selected grayscale printing without recognizing that the document has a color portion. Further, if the two preview images are compared with each other and it is found that a portion in the former preview image is presented in color and the corresponding portion in the latter preview image is also presented in color, it can be found at an early stage that, for a document that has a color portion but that is to be printed in grayscale for cost-saving or the like, a user has selected color printing.

The evaluation value for a page and the relation between the evaluation value and the priority are also used in the fifth embodiment as in the fourth embodiment. For example, the evaluation value is calculated as follows:

evaluation value=the size of the smallest color area/sheet size (if one or more color areas are present) (7), or

evaluation value=1 (if no color area is present) (8).

Then, a rule under which a page having a smaller evaluation value is prioritized is applied.

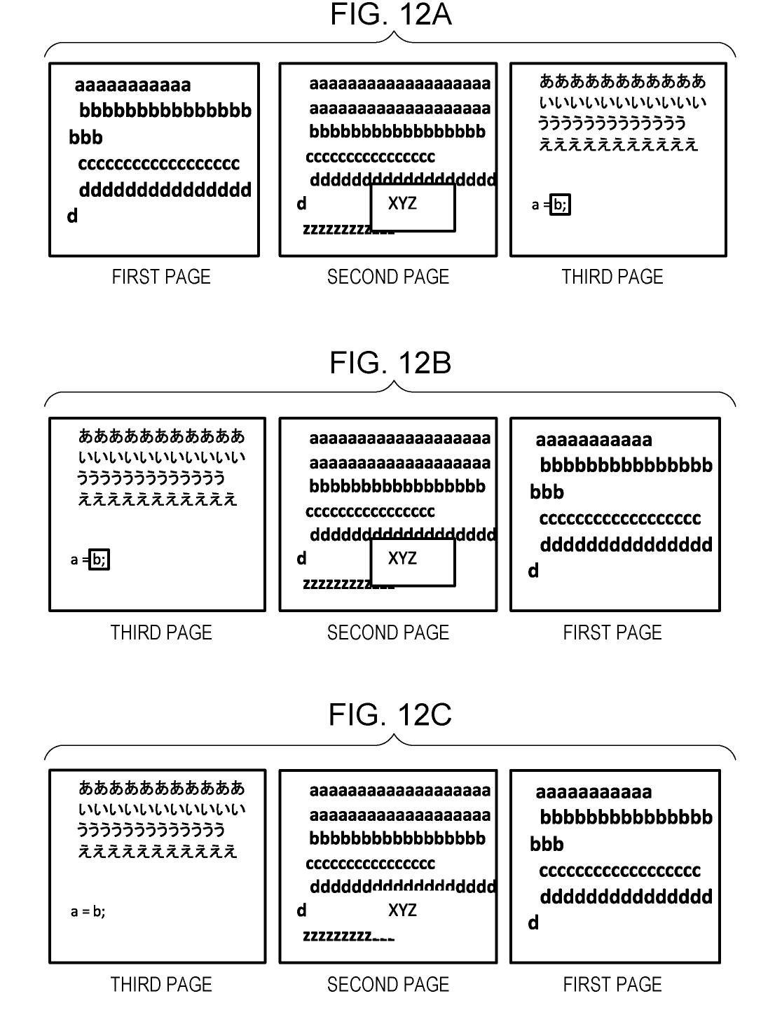

For example, as illustrated in FIG. 12A, in a case where the evaluation value for the first page having no color portion is equal to 1 and the evaluation value for the third page is smaller than the evaluation value for the second page because the third page has a color portion indicated by a frame that is smaller than a frame indicating a color portion on the second page, in other words, in a case where the evaluation value for each page decreases with the order the first, second, and third pages, preview images having the sequences illustrated in FIG. 12B and in FIG. 12C are placed on a single screen.

The user interface according to the fifth embodiment is the same as or similar to the user interface according to the fourth embodiment. The fifth embodiment differs from the fourth embodiment in that preview images with colors in the document retained without changing and preview images processed in accordance with the selected color modes are simultaneously placed.

### Sixth Embodiment

According to a sixth embodiment of the present disclosure, a document having a specific keyword (such as “important”, “internal use only”, or “summary”) can be checked at an early stage. A keyword that is likely to be included on a document that is to be checked at an early stage is set, and then a page having the keyword is prioritized in previewing. Not only a single keyword but also a plurality of keywords may be set, and a page having any of the plurality of keywords may be prioritized in previewing. Further, found keywords may be displayed next to preview images.

A method of processing from previewing to printing according to the sixth embodiment is the same as or similar to the method according to the first embodiment illustrated in FIG. 1 and FIG. 2 or 3, and thus a duplicate description will be omitted.

Next, step S203, in which the priority of a page is determined, will be described in detail.

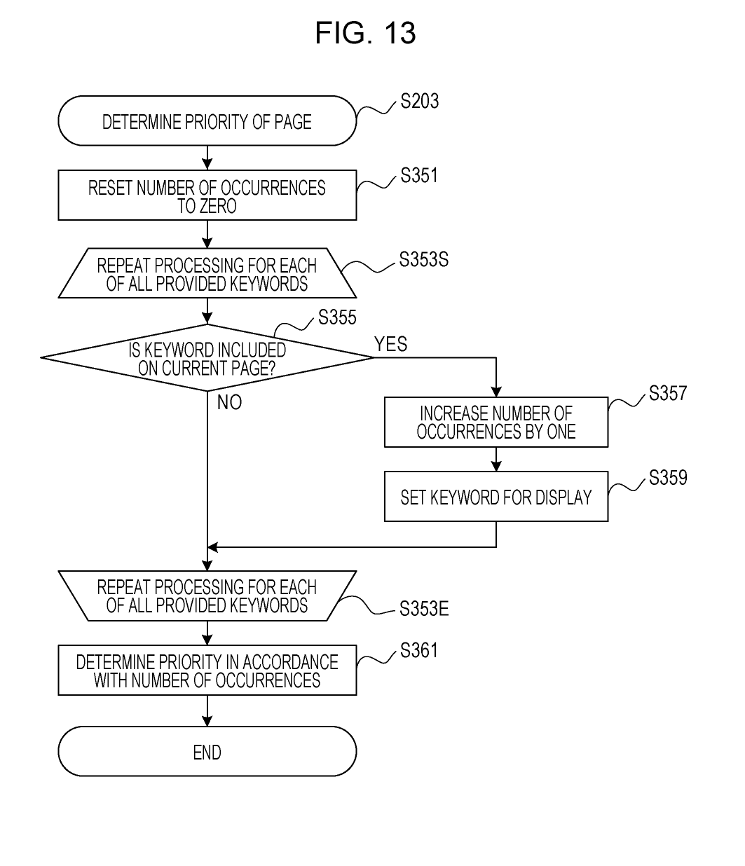

As illustrated in FIG. 13, the number of occurrences is reset to zero in the beginning (step S351).

Then, for each of all the provided keywords, processing from step S353S to step S353E is repeated.

In each repetition, if the current keyword is included on the page (YES in step S355), the number of occurrences is increased by one (step S357), and the current keyword is set for display (step S359).

When the repetition finishes, the priority is determined in accordance with the number of occurrences (step S361). Specifically, if a rule is specified that a larger value indicates a higher priority, the number of occurrences may be used as the priority without changing. If a rule is specified that a smaller value indicates a higher priority, the number of occurrences with a minus sign may be used as the priority.

The maximum number of occurrences for a keyword may be set to a predetermined value (for example, 1). In this case, pages in which the same keyword is found are not to be rearranged. Further, the number of occurrences may be increased by the increment depending on a keyword. In other words, when pages are prioritized, each keyword may have a different degree of importance. Further, the maximum number of occurrences for all the keywords may be set to a predetermined value (for example, 1). In this case, pages in which any of the keywords is found are not to be rearranged.

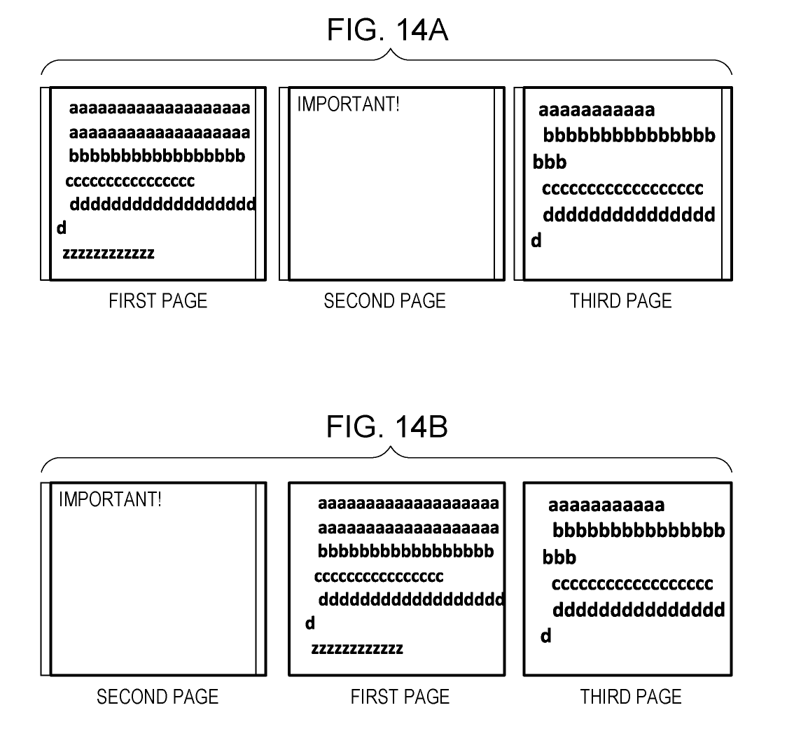

For example, as illustrated in FIG. 14A, if the numbers of occurrences for the first page and for the third page are equal to zero and the number of occurrences for the second page is equal to 1, the preview images are displayed in order of decreasing number of occurrences as illustrated in FIG. 14B.

The user interface according to the sixth embodiment is the same as or similar to the user interface according to the first embodiment.

However, in the first embodiment, each scanned page is subjected to character recognition processing, and consequently text characters included on each page and the sizes of the text characters are obtained. If it is determined by using a predetermined method that a page having small text characters is present among the scanned pages, a dialog box presenting a question “A page having many small text characters is present. Change settings?” is displayed as illustrated in FIG. 24, and if “Yes” is selected, additional buttons for transitioning to the setting change screen are displayed as illustrated in FIG. 25.

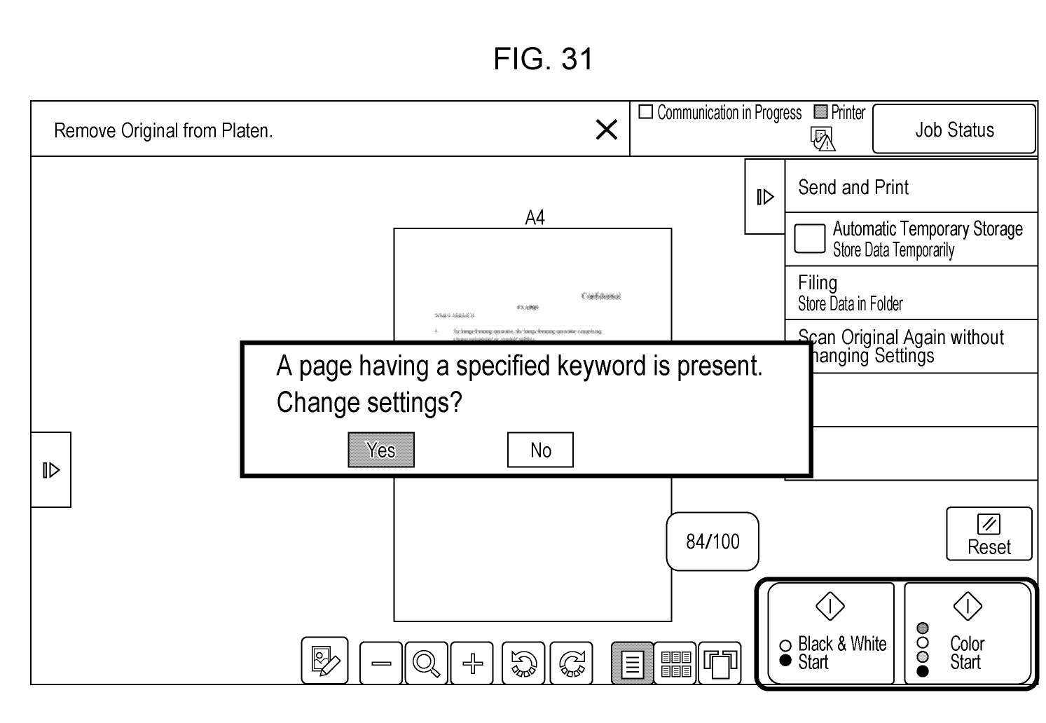

In contrast, in the sixth embodiment, the number of occurrences for each scanned page is calculated by using the method illustrated in FIG. 13. If it is determined that a page having a nonzero number of occurrences is present among the scanned pages, a dialog box presenting a question “A page having a specified keyword is present. Change settings?” is displayed as illustrated in FIG. 31. If “Yes” is selected, additional buttons for transitioning to the setting change screen are displayed as illustrated in FIG. 25.

### Seventh Embodiment

According to a seventh embodiment of the present disclosure, a page having an image can be checked at as early stage. To achieve this goal, a page having an image is prioritized in previewing. Of pages having an image, for example, a page having many images may be prioritized in previewing, or a page having a large total image area may be prioritized in previewing.

A method of processing from previewing to printing according to the seventh embodiment is the same as or similar to the method according to the first embodiment illustrated in FIG. 1 and FIG. 2 or 3, and thus a duplicate description will be omitted.

Next, step S203, in which the priority of a page is determined, will be described in detail.

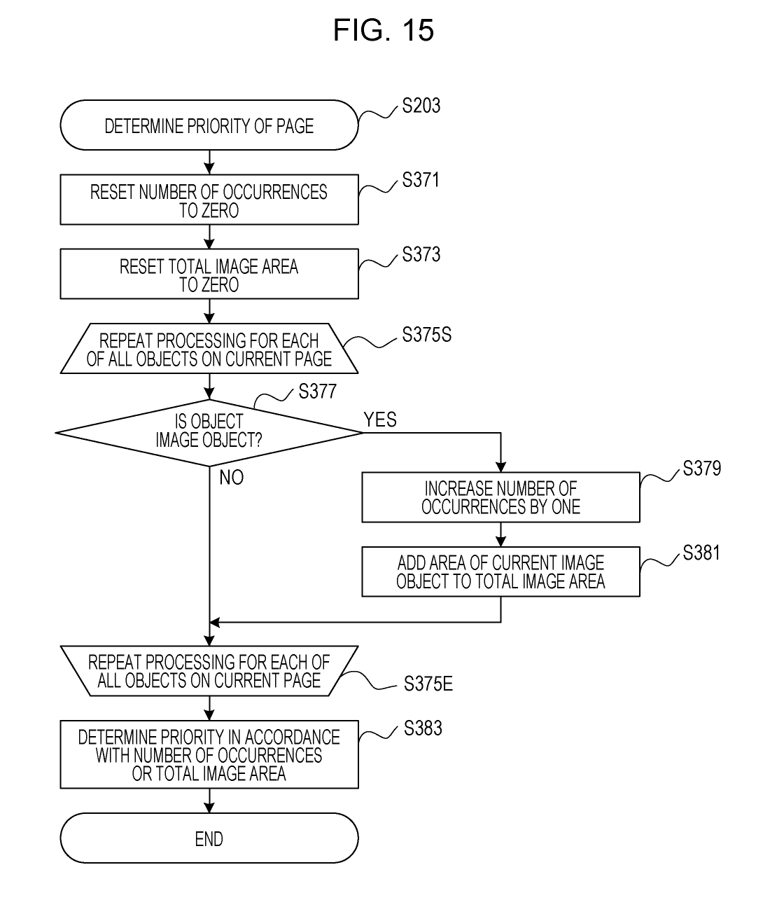

As illustrated in FIG. 15, the number of occurrences is reset to zero (step S371), and the total image area is also reset to zero (step S373) in the beginning.

Then, for each of all the objects on the page, processing from step S375S to step S375E is repeated.

In the repetition, if an object is an image object (YES in step S377), the number of occurrences is increased by one (step S379), and the area of the current image object is added to the total image area (step S381).

When the repetition finishes, the priority is determined in accordance with the number of occurrences or the total image area (step S383). Specifically, if a rule is specified that a larger value indicates a higher priority, the number of occurrences or the total image area may be used as the priority without changing. If a rule is specified that a smaller value indicates a higher priority, the number of occurrences or the total image area with a minus sign may be used as the priority.

The maximum number of occurrences may be set to a predetermined value (for example, 1). In this case, pages in which images are found are not to be rearranged.

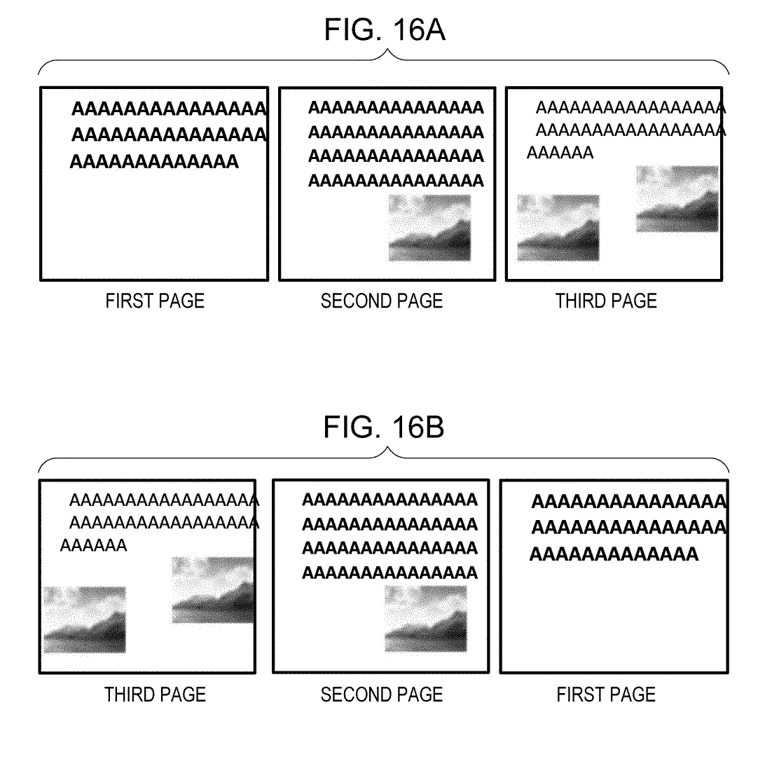

For example, as illustrated in FIG. 16A, if the number of occurrences for the first page is equal to zero, the number of occurrences for the second page is equal to 1, and the number of occurrences for the third page is equal to 2, preview images are displayed in order of decreasing number of occurrences as illustrated in FIG. 16B.

The user interface according to the seventh embodiment is the same as or similar to the user interface according to the first embodiment.

However, in the first embodiment, each scanned page is subjected to character recognition processing, and consequently text characters included on each page and the sizes of the text characters are obtained. If it is determined by using a predetermined method that a page having small text characters is present among the scanned pages, a dialog box presenting a question “A page having many small text characters is present. Change settings?” is displayed as illustrated in FIG. 24, and if “Yes” is selected, additional buttons for transitioning to the setting change screen are displayed as illustrated in FIG. 25.

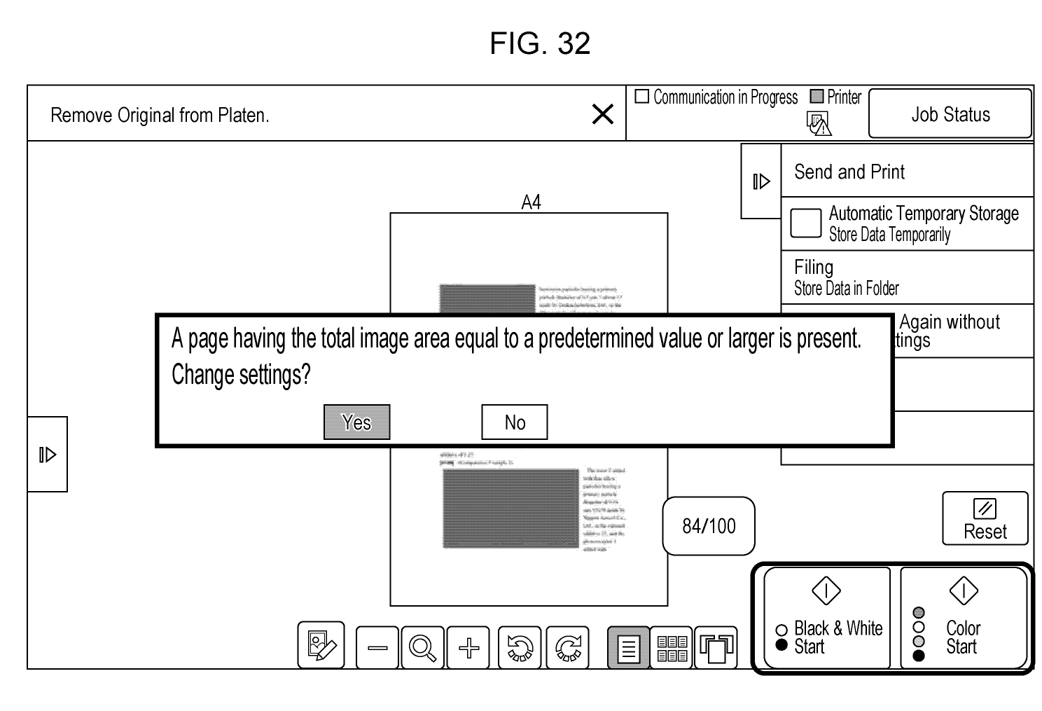

In contrast, in the seventh embodiment, the total image area for each scanned page is calculated by using the method illustrated in FIG. 15. If it is determined that a page having the total image area equal to a predetermined value or larger is present among the scanned pages, a dialog box presenting a question “A page having the total image area equal to a predetermined value or larger is present. Change settings?” is displayed as illustrated in FIG. 32. If “Yes” is selected, additional buttons for transitioning to the setting change screen are displayed as illustrated in FIG. 25.

### Eighth Embodiment

According to an eighth embodiment of the present disclosure, a page having a table can be checked at an early stage. To achieve this goal, a page having a table is prioritized in previewing. Of pages having a table, for example, a page having many tables may be prioritized in previewing, or a page having a large total table area may be prioritized in previewing.

A method of processing from previewing to printing according to the eighth embodiment is the same as or similar to the method according to the first embodiment illustrated in FIG. 1 and FIG. 2 or 3, and thus a duplicate description will be omitted.

Next, step S203, in which the priority of a page is determined, will be described in detail.

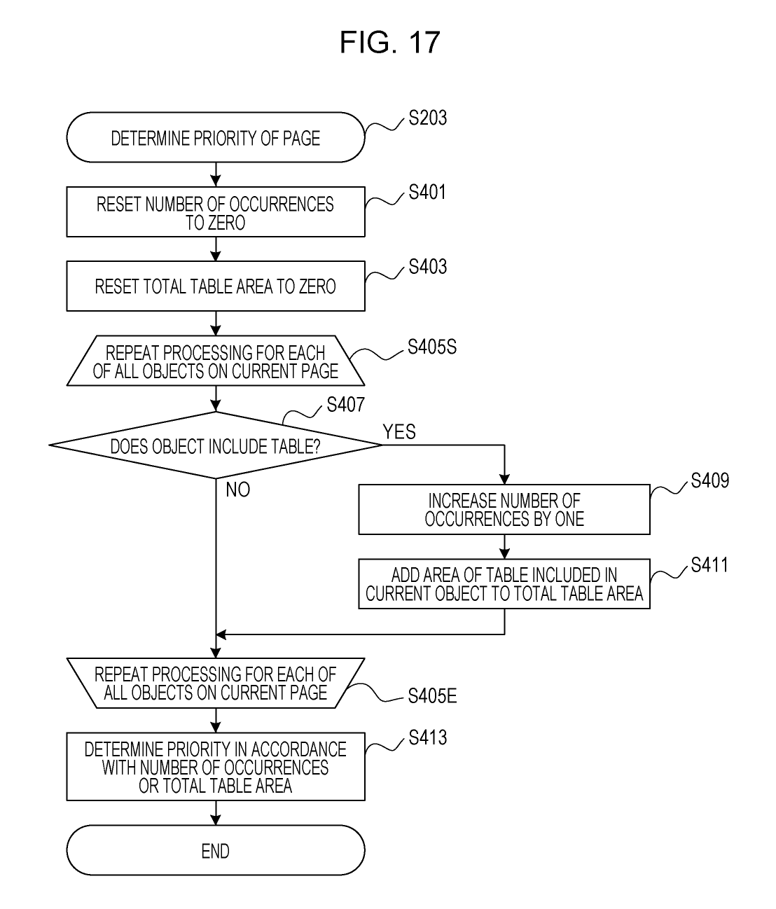

As illustrated in FIG. 17, the number of occurrences is reset to zero (step S401), and the total table area is also reset to zero (step S403) in the beginning.

Then, for each of all the objects on the page, processing from step S405S to step S405E is repeated.

In the repetition, if an object includes a table (YES in step S407), the number of occurrences is increased by one (step S409, and the area of the table included in the current object is added to the total table area (step S411). If a table object is detected after each object included on a page has been developed, the number of occurrences is increased by one. Further, for example, if a table constituted by ruled lines represented by the Shift_JIS code is found in a text character sequence, the number of occurrences is increased by one for the entire table, and the area of the table is added to the total table area.

When the repetition finishes, the priority is determined in accordance with the number of occurrences or the total table area (step S413). Specifically, if a rule is specified that a larger value indicates a higher priority, the number of occurrences or the total table area may be used as the priority without changing. If a rule is specified that a smaller value indicates a higher priority, the number of occurrences or the total table area with a minus sign may be used as the priority.

The maximum number of occurrences may be set to a predetermined value (for example, 1). In this case, pages in which tables are found are not to be rearranged.

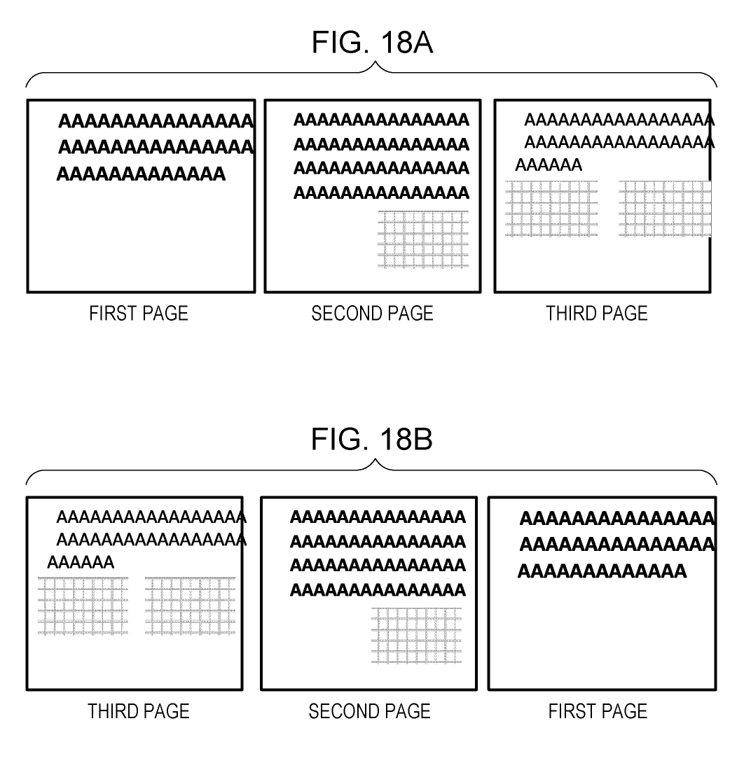

For example, as illustrated in FIG. 18A, if the number of occurrences for the first page is equal to zero, the number of occurrences for the second page is equal to 1, and the number of occurrences for the third page is equal to 2, preview images are displayed in order of decreasing number of occurrences as illustrated in FIG. 18B.

The user interface according to the eighth embodiment is the same as or similar to the user interface according to the first embodiment.

However, in the first embodiment, each scanned page is subjected to character recognition processing, and consequently text characters included on each page and the sizes of the text characters are obtained. If it is determined by using a predetermined method that a page having small text characters is present among the scanned pages, a dialog box presenting a question “A page having many small text characters is present. Change settings?” is displayed as illustrated in FIG. 24, and if “Yes” is selected, additional buttons for transitioning to the setting change screen are displayed as illustrated in FIG. 25.

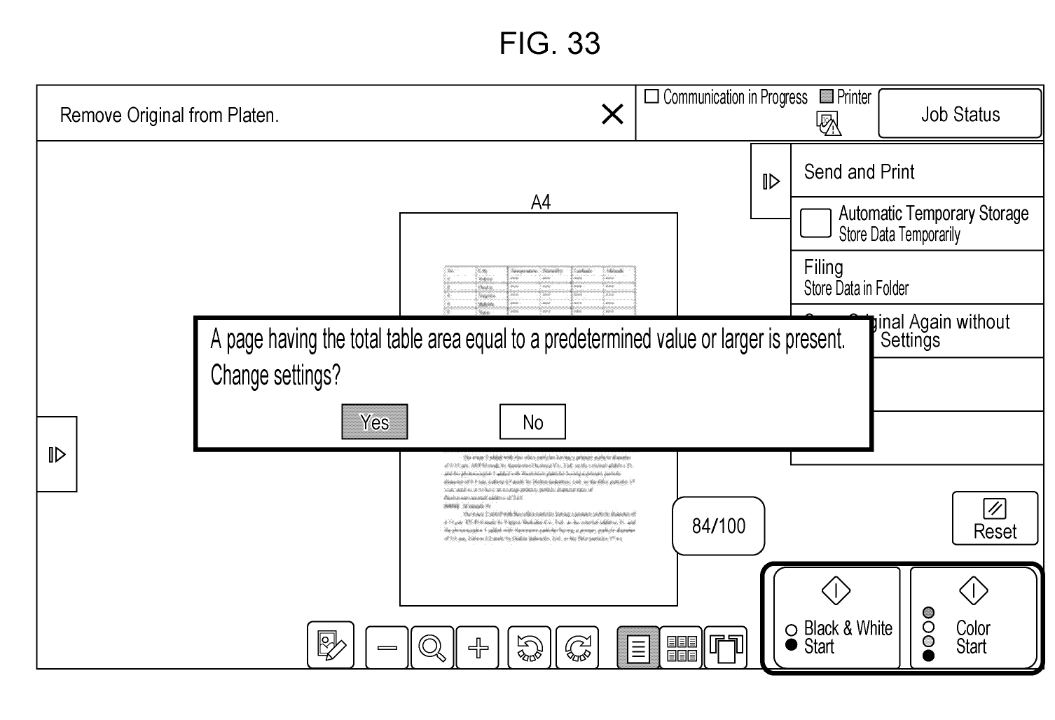

In contrast, in the eighth embodiment, the total table area for each scanned page is calculated by using the method illustrated in FIG. 17. If it is determined that a page having the total table area equal to a predetermined value or larger is present among the scanned pages, a dialog box presenting a question “A page having the total table area equal to a predetermined value or larger is present. Change settings?” is displayed as illustrated in FIG. 33. If “Yes” is selected, additional buttons for transitioning to the setting change screen are displayed as illustrated in FIG. 25.

### Ninth Embodiment

According to a ninth embodiment of the present disclosure, the extent of a change in image contents from document contents, the change being caused by the application of a background removal function to an image obtained by scanning a document by using a document scanner, can be checked at an early stage, and a parameter such as a threshold used in the background removal function can be adjusted accordingly at an early stage. The background removal function is a function to remove contents due to show-through from the other side of a sheet of a document that is produced, for example, by using double-sided printing. For example, if settings in which a density equal to or lower than a predetermined threshold is set to zero are used and contents due to show-through from the other side of a sheet have a density equal to or lower than the threshold, the contents due to the show-through from the other side of the sheet can be removed. However, depending on the relation between a predetermined threshold level and the density of contents printed on a surface to be scanned, the background removal function is sometimes applied to the contents printed on the surface to be scanned. A user deals with such a case, for example, by reducing the threshold in spite of the possibility of causing the background removal function to be insufficient. In the present embodiment, a page to which the background removal function has been applied is prioritized in previewing, and thus the threshold can be checked for the adequacy and adjusted accordingly at an early stage.

Document images scanned by a document scanner are printed by an image forming apparatus or stored in a storage device.

The background removal function may also be applied when a surface on which contents due to show-through have been printed is scanned by a document scanner or when a document having contents due to show-through is printed in accordance with instructions from a computer that retains the data of the document.

A method of processing from previewing to printing according to the ninth embodiment is the same as or similar to the method according to the first embodiment illustrated in FIG. 1 and FIG. 2 or 3, and thus a duplicate description will be omitted.

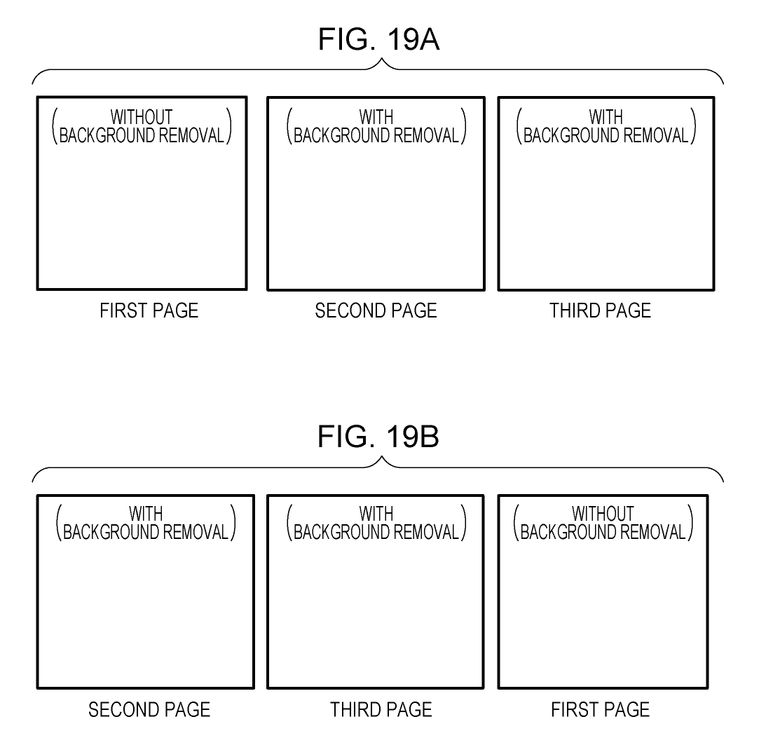

For example, as illustrated in FIG. 19A, when the first page has not been subjected to the background removal processing and the second and third pages have been subjected to the background removal processing, the pages that have been subjected to the background removal processing are prioritized in previewing as illustrated in FIG. 19B.

In the above embodiments, a device driver in a computer that causes a multifunction peripheral to print may have a preview display function, or a multifunction peripheral that receives instructions for printing from a computer may have the preview display function.

In the embodiments in which a magnification or reduction ratio is adjusted, a device driver in a computer that causes a multifunction peripheral to print may have such a function to adjust the magnification or reduction ratio, or a multifunction peripheral that receives instructions for printing from a computer may have such a function to adjust the magnification or reduction ratio.

In addition, a multifunction peripheral may perform the preview display function before a multipage document scanned by using a document scanner is printed at a single time or before a multipage document read from a storage device is printed at a single time.

Further, a multifunction peripheral may perform the preview display function before transmitting a multipage document (for example, facsimile transmission and email transmission).

The user interface according to the ninth embodiment is the same as or similar to the user interface according to the first embodiment.

However, in the first embodiment, each scanned page is subjected to character recognition processing, and consequently text characters included on each page and the sizes of the text characters are obtained. If it is determined by using a predetermined method that a page having small text characters is present among the scanned pages, a dialog box presenting a question “A page having many small text characters is present. Change settings?” is displayed as illustrated in FIG. 24, and if “Yes” is selected, additional buttons for transitioning to the setting change screen are displayed as illustrated in FIG. 25.

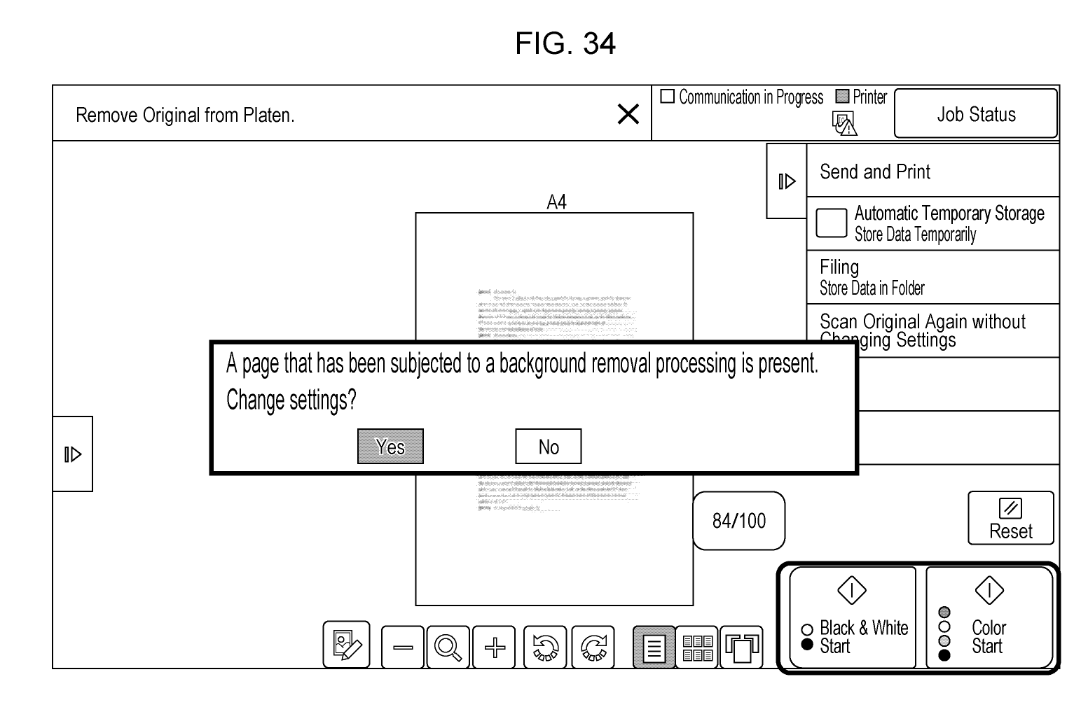

In contrast, in the ninth embodiment, it is determined whether each scanned page has been subjected to the background removal processing. If it is determined that a page that has been subjected to the background removal processing is present among the scanned pages, a dialog box presenting a question “A page that has been subjected to a background removal processing is present. Change settings?” is displayed as illustrated in FIG. 34, and if “Yes” is selected, additional buttons for transitioning to the setting change screen are displayed as illustrated in FIG. 25.

### Tenth Embodiment

A tenth embodiment is a combination of the first to ninth embodiments. For example, a page to be prioritized in previewing in some of the first to ninth embodiments may be prioritized in previewing, and afterwards a page to be prioritized in previewing in none of the first to ninth embodiments may be previewed. In addition, the priority may be determined in accordance with a combination of evaluation values in some of the embodiments.

### Eleventh Embodiment

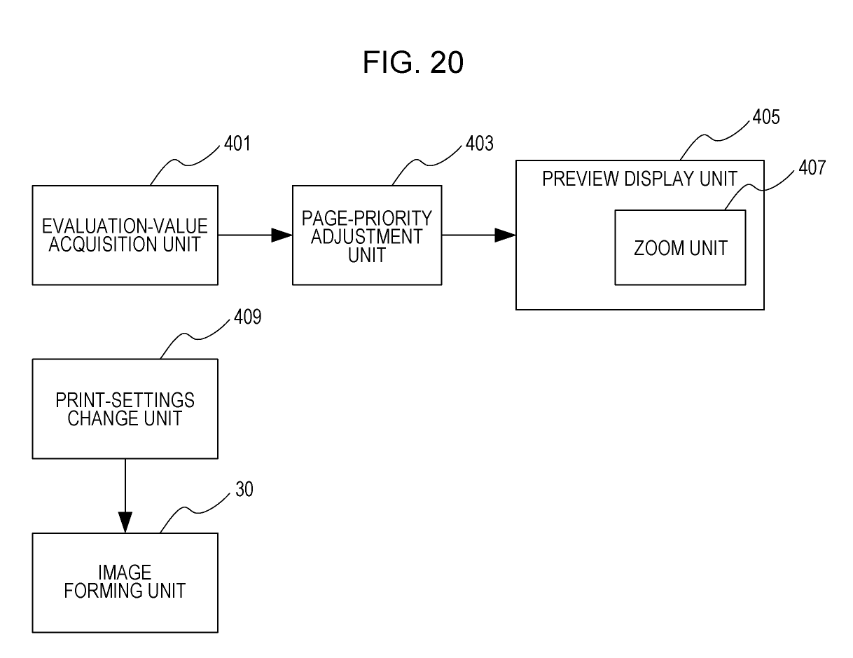

FIG. 20 is a block diagram illustrating a configuration of a preview display apparatus according to an eleventh embodiment for performing the preview display methods according to the first to tenth embodiments.

Referring to FIG. 20, the preview display apparatus includes an evaluation-value acquisition unit 401, a page-priority adjustment unit 403, a preview display unit 405, a zoom unit 407, and a print-settings change unit 409.

The evaluation-value acquisition unit 401 acquires in accordance with a predetermined purpose an evaluation value for each page among a plurality of pages to preview.

The page-priority adjustment unit 403 adjusts the priorities of the plurality of pages in accordance with the evaluation values.

The preview display unit 405 displays a preview image of each of the plurality of pages in accordance with the priority adjusted by the page-priority adjustment unit 403.

The zoom unit 407 zooms in on a portion of a preview image.

The print-settings change unit 409 changes print settings for at least one of the plurality of pages in an image forming unit 30 after the preview display unit 405 displays preview images.

### Twelfth Embodiment

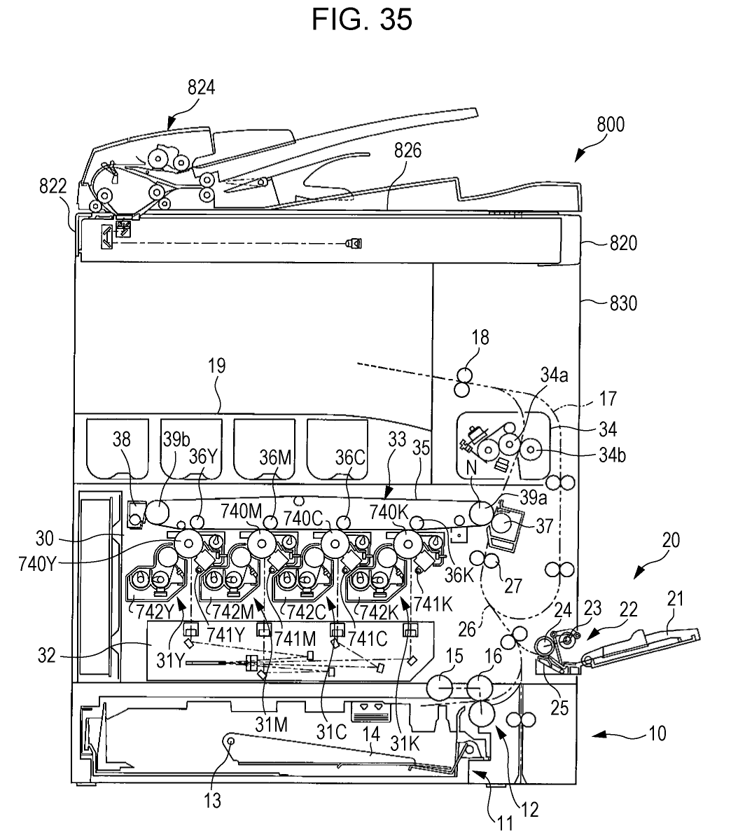

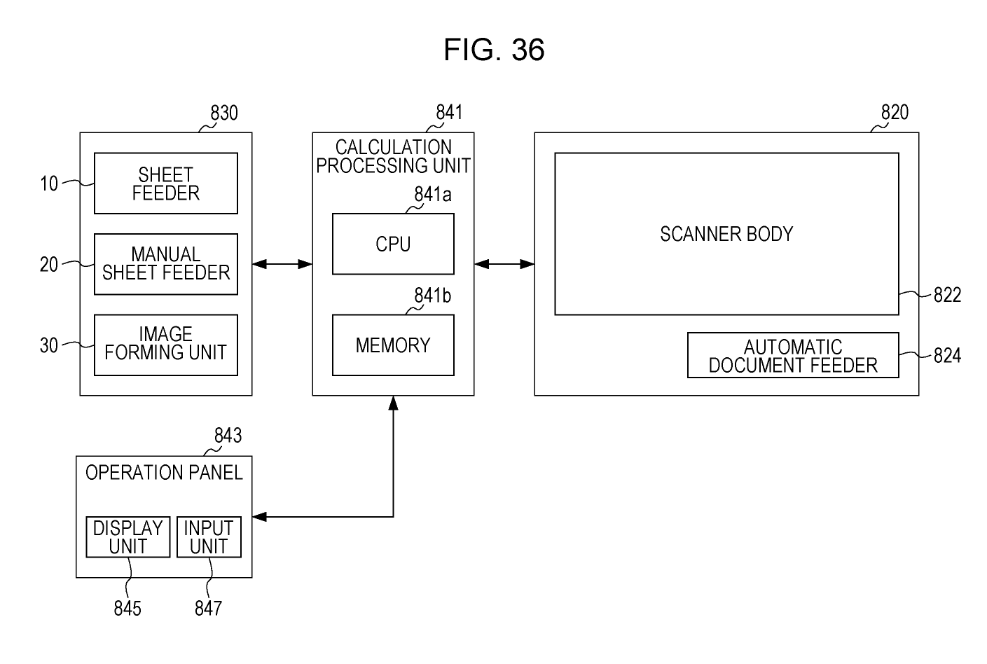

A twelfth embodiment relates to a multifunction peripheral 800 that includes the document scanner according to the first to ninth embodiments. FIGS. 35 and 36 illustrate a configuration and the like of the multifunction peripheral 800.

As illustrated in FIGS. 35 and 36, the multifunction peripheral 800 includes a document scanner 820 that scans a document image, a multifunction peripheral body 830 (body of an image forming unit) that forms an image on a sheet, an operation panel 843 for operating the document scanner 820 and the multifunction peripheral body 830, and a calculation processing unit 841 that controls the document scanner 820 and the multifunction peripheral body 830 in accordance with an operation performed on the operation panel 843.

The document scanner 820 can be used for image scanning on a stand-alone basis, or the multifunction peripheral body 830 can be used for image forming on a stand-alone basis. In addition, the document scanner 820 and the multifunction peripheral body 830 can be operated in combination for image copying. In addition, the multifunction peripheral 800 may include a storage device or a facsimile device, neither of which is shown. The storage device can store images scanned by the document scanner 820 and images received by the facsimile device. The facsimile device can transmit images scanned by the document scanner 820 or stored in the storage device and receive images from outside. Furthermore, the multifunction peripheral 800 may include an interface for connecting to a personal computer via a network. The personal computer connected to the multifunction peripheral 800 can use a function of the multifunction peripheral 800 to process the data that can be managed by the personal computer.

The document scanner 820 includes an automatic document feeder 824 (single pass feeder or SPF) that automatically feeds a document and a scanner body 822 that scans a document image. The document scanner 820 includes, in addition to the components illustrated in FIG. 36, components that are not illustrated in FIG. 36 but illustrated in FIG. 35. The scanner body 822 also includes a platen 826 as illustrated in FIG. 35.

The multifunction peripheral body 830 includes a sheet feeder 10 that feeds a sheet, a manual sheet feeder 20 that enables manual sheet feeding, and the image forming unit 30 that forms an image on a sheet fed by the sheet feeder 10 or the manual sheet feeder 20.

The sheet feeder 10 includes a sheet housing unit 11 that houses sheets and a separating feeder 12 that separately feeds sheets housed in the sheet housing unit 11 one by one. The sheet housing unit 11 includes an inner plate 14 that pivots around a rotating shaft 13, and the inner plate 14 lifts a sheet by pivoting when the sheet is fed. The separating feeder 12 includes a pick-up roller 15 that feeds a sheet lifted by the inner plate 14 and a separating roller pair 16 that separates sheets that are fed by the pick-up roller 15 one by one.

The manual sheet feeder 20 includes a manual feed tray 21 that can contain sheets and a separating feeder 22 that separately feeds sheets in the manual feed tray 21 one by one. The manual feed tray 21 is pivotally supported by the multifunction peripheral body 830 and is fixed at a predetermined angle to accommodate a sheet when the sheet is fed manually. The separating feeder 22 includes a pick-up roller 23 that feeds a sheet in the manual feed tray 21 and a separating roller 24 and a separating pad 25 that separate sheets that are fed by the pick-up roller 23 one by one.

The image forming unit 30 includes four process cartridges 31Y, 31M, 31C, and 31K that form yellow (Y), magenta (N), cyan (C), and black (K) images and photosensitive drums 740Y, 740M, 740C, and 740K described below. The image forming unit 30 also includes an exposure unit 32 by which surfaces of the photosensitive drums 740Y, 740M, 740C, and 740K are exposed to light, a transfer unit 33 that transfers toner images formed on the surfaces of the photosensitive drums 740Y, 740M, 740C, and 740K to a sheet, and a fixing unit 34 that fixes transferred toner images to the sheet. The alphabetical character (Y, M, C, or K) appended to each of the numerals represents the respective color (yellow, magenta, cyan, or black).

Each of the four process cartridges 31Y, 31M, 31C, and 31K is designed to be detachable from the multifunction peripheral body 830 and replaceable. The four process cartridges 31Y, 31M, 31C, and 31K are designed to have similar construction except for a color used to form an image. Thus, only the construction of the process cartridge 31Y that forms an image of yellow (Y) will be described, and the process cartridges 31M, 31C, and 31K will not be repeatedly described.

The process cartridge 31Y includes the photosensitive drum 740Y as an image carrying member, a charging unit 741Y that electrically charges the photosensitive drum 740Y, a developing unit 742Y that develops an electrostatic latent image formed on the photosensitive drum 740Y, and a drum cleaner that removes toner remaining on the surface of the photosensitive drum 740Y. The developing unit 742Y includes a developing unit body (not shown in detail) that develops the electrostatic latent image formed on the photosensitive drum 740Y and a toner cartridge (not shown in detail) that supplies toner to the developing unit body. The toner cartridge is designed to be detachable from the developing unit body and can be removed from the developing unit body and replaced when the contained toner is exhausted.

The exposure unit 32 includes a light source (not shown in detail) that emits a laser beam, a plurality of mirrors (not shown in detail) that guide the laser beam to the photosensitive drums 740Y, 740M, 740C, and 740K, and other components. The transfer unit 33 includes an intermediate transfer belt 35 that carries toner images formed on the photosensitive drums 740Y, 740M, 740C, and 740K, primary transfer rollers 36Y, 36M, 36C, and 36K that perform primary transfer of the toner images formed on the photosensitive drums 740Y, 740M, 740C, and 740K to the intermediate transfer belt 35, a secondary transfer roller 37 that performs secondary transfer of a toner image transferred to the intermediate transfer belt 35 to a sheet, and a belt cleaner 38 that removes toner remaining on the intermediate transfer belt 35. The intermediate transfer belt 35 is wound around a drive roller 39a and an idle roller 39b and pressed against the photosensitive drums 740Y, 740M, 740C, and 740K by the primary transfer rollers 36Y, 36M, 36C, and 36K, respectively. The secondary transfer roller 37 nips (pinches) the intermediate transfer belt 35 with the drive roller 39a and transfers, at a nip portion N, the toner image carried by the intermediate transfer belt 35 to a sheet. The fixing unit 34 includes a heat roller 34a that heats a sheet and a pressure roller 34b that is pressed against the heat roller 34a.

The operation panel 843 includes a display unit 845 that displays predetermined information and an input unit 847 used by a user to input instructions to the document scanner 820 and the multifunction peripheral body 830. In the present embodiment, the operation panel 843 is disposed on the front side of the scanner body 822. The front side and the back side of the scanner body 822 refer to one front side and the back side, respectively, of the sheet of FIG. 35.

As illustrated in FIG. 36, the calculation processing unit 841 includes a central processing unit (CPU) 841a that controls driving of the sheet feeder 10, the manual sheet feeder 20, the image forming unit 30, and the document scanner 820 and a memory 841b that stores various programs to operate the CPU 841a and various pieces of information that are used by the CPU 841a. The calculation processing unit 841 forms an image on a sheet by coordinately controlling operation of the sheet feeder 10, the manual sheet feeder 20, the image forming unit 30, and the document scanner 820 in accordance with an operation performed on the operation panel 843 by the user.

Next, an image formation operation (image formation control performed by the calculation processing unit 841) performed by the multifunction peripheral 800 configured as described above will be described. In the present embodiment, as an example, a description will be given of an image forming operation in which the image forming unit 30 forms, on a sheet fed by the sheet feeder 10, an image of a document that is fed by the automatic document feeder 824 and scanned by the scanner body 822.

When an image forming start signal is output in accordance with an input by a user to the input unit 847 of the operation panel 843, a document that has been placed on the automatic document feeder 824 by the user is automatically fed toward a document scanning position, and an image of the document is scanned at the document scanning position by the scanner body 822.

Once the image of the document is scanned by the scanner body 822, a plurality of laser beams are emitted onto the corresponding photosensitive drums 740Y, 740M, 740C, and 740K from the exposure unit 32 in accordance with image information of the scanned document. The photosensitive drums 740Y, 740M, 740C, and 740K have been charged in advance by the charging units 741Y, 741M, 741C, and 741K, respectively. Then, each of the photosensitive drums 740Y, 740M, 740C, and 740K is irradiated with a corresponding laser beam, which forms a respective electrostatic latent image on each of the photosensitive drums 740Y, 740M, 740C, and 740K. The electrostatic latent images formed on the photosensitive drums 740Y, 740M, 740C, and 740K are developed by the developing units 742Y, 742M, 742C, and 742K, respectively, and toner images of yellow (Y), magenta (M), cyan (C), and black (K) are formed on the photosensitive drums 740Y, 740M, 740C, and 740K. The toner images of respective colors formed on the photosensitive drums 740Y, 740M, 740C, and 740K are transferred to the intermediate transfer belt 35 by using the respective primary transfer rollers 36Y, 36M, 36C, and 36K to be superimposed on each other. A transferred and superimposed toner image (full-color toner image) is carried on the intermediate transfer belt 35 and conveyed to the nip portion N.

Simultaneously with the aforementioned image forming operation, sheets housed in the sheet housing unit 11 are separated one by one by the separating feeder 12 and conveyed to a sheet conveying path 26 by the pick-up roller 15. Then, an obliquely conveyed sheet is corrected at a registration roller pair 27 disposed upstream of the nip portion N in the sheet conveying direction, and the sheet is conveyed to the nip portion N at a predetermined conveyance timing. The full-color toner image carried by the intermediate transfer belt 35 is transferred by the secondary transfer roller 37 to the sheet conveyed to the nip portion N.

The sheet to which the toner image has been transferred is heated and pressed in the fixing unit 34, and the toner image is melted and fixed, after which the sheet is discharged from the body by a discharge roller pair 18 and contained in a discharge sheet containing unit 19.

When images are formed on both sides (a first side and a second side) of a sheet, before the sheet that has an image formed on the first side of the sheet is discharged from the body, the sheet is conveyed to a duplex conveying path 17 by reverse rotation of the discharge roller pair 18 and then returned to the image forming unit 30 through the duplex conveying path 17. Then, an image is formed on the second side of the sheet in a manner similar to the first side, and the sheet is discharged from the body. The sheet discharged from the body is contained in the discharge sheet containing unit 19.

The aforementioned preview display apparatus can be realized by using hardware, software, or a combination of hardware and software. A method for preview display performed by the aforementioned preview display apparatus can also be realized by using hardware, software, or a combination of hardware and software. Realization by software mentioned here indicates realization by using a computer that reads and executes a program.

The program can be stored on various kinds of non-transitory computer readable media and supplied to the computer. The various kinds of non-transitory computer readable media include tangible storage media of various types. Examples of the non-transitory computer readable media include a magnetic recording medium (for example, a flexible disk, a magnetic tape, or a hard-disk drive), a magneto-optical recording medium (for example, a magneto-optical disk), a compact-disk read-only memory (CD-ROM), a CD-R, a CD-R/W, a semiconductor memory (for example, a mask ROM, a programmable ROM (PROM), an erasable PROM (EPROM), a flash ROM, or a random access memory (RAM)). The program may be supplied to the computer by using transitory computer readable media of various types. Examples of the transitory computer readable media include electric signals, optical signals, and electromagnetic waves. The transitory computer readable medium can supply the program via a wired transmission path, such as electric wires or optical fibers, or via a wireless transmission path.

The present disclosure can be executed in various different forms without departing from the spirit and major features of the present disclosure. Thus, each of the embodiments described above is merely illustrative and is not meant to be limiting. The scope of the present disclosure is defined by the claims and is not constrained by the specification in any way. Further, modifications and changes within the scope and range of equivalents of the claims are all within the scope of the present disclosure.

The embodiments of the present disclosure can be used for preview display of a document.

The present disclosure contains subject matter related to that disclosed in Japanese Priority Patent Application JP 2017-249335 filed in the Japan Patent Office on Dec. 26, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A preview display apparatus comprising:
an evaluation-value acquisition unit that acquires an evaluation value for each of a plurality of pages in accordance with a predetermined purpose, the plurality of pages being to be previewed;
a page-priority adjustment unit that adjusts a priority of each of the plurality of pages in accordance with the evaluation value for the page; and
a preview display unit that displays a preview image of each of the plurality of pages in accordance with the priority of the page adjusted by the page-priority adjustment unit.

2. The preview display apparatus according to claim 1,
wherein the evaluation value takes multiple values or binary values.

3. The preview display apparatus according to claim 1, further comprising:
a print-settings change unit that changes print settings for at least one of the plurality of pages after the preview display unit displays the preview image of each of the plurality of pages.

4. The preview display apparatus according to claim 1, further comprising:
a zoom unit that zooms in on a portion of the preview image of each of the plurality of pages.

5. The preview display apparatus according to claim 1,
wherein the predetermined purpose is for a user
to find a print page having a text character whose text size for printing is excessively small,
to find a print page that has an overflowing portion,
to be informed that a second section or a subsequent section in a document to print does not begin at a top of a print page,
to be informed that a color portion of a document to print is to be printed in monochrome against an intention of the user to print in color,
to be informed that a color portion of a document to print is to be printed in color against an intention of the user to print in monochrome,
to check a page having a predetermined keyword on a preview screen,
to check a page having an image on a preview screen,
to check a page having a table on a preview screen,
to check on a preview screen a page to which a background removal function has been applied, or
any combination thereof.

6. The preview display apparatus according to claim 5,
wherein the evaluation-value acquisition unit acquires from each page as the evaluation value for the page an evaluation value relating to a text size so that the user finds a print page having a text character whose text size for printing is excessively small.

7. The preview display apparatus according to claim 5,
wherein the evaluation-value acquisition unit acquires from each page as the evaluation value for the page an evaluation value relating to a blank portion ratio so that the user finds a print page that has an overflowing portion.

8. The preview display apparatus according to claim 5,
wherein the evaluation-value acquisition unit acquires from each page as the evaluation value for the page an evaluation value relating to an amount of a blank near a top of the page so that the user is informed that a second section or a subsequent section in a document to print does not begin at a top of a print page.

9. The preview display apparatus according to claim 5,
wherein the evaluation-value acquisition unit acquires from each page as the evaluation value for the page an evaluation value relating to a ratio of a color portion so that the user is informed that a color portion of a document to print is to be printed in monochrome against an intention of the user to print in color.

10. The preview display apparatus according to claim 5,
wherein the evaluation-value acquisition unit acquires from each page as the evaluation value for the page an evaluation value relating to a ratio of a color portion so that the user is informed that a color portion of a document to print is to be printed in color against an intention of the user to print in monochrome.

11. The preview display apparatus according to claim 5,
wherein the evaluation-value acquisition unit acquires from each page as the evaluation value for the page an evaluation value relating to whether the page has a predetermined keyword so that the user checks a page having a predetermined keyword on a preview screen.

12. The preview display apparatus according to claim 5,
wherein the evaluation-value acquisition unit acquires from each page as the evaluation value for the page an evaluation value relating to whether the page has an image so that the user checks a page having an image on a preview screen.

13. The preview display apparatus according to claim 5,
wherein the evaluation-value acquisition unit acquires from each page as the evaluation value for the page an evaluation value relating to whether the page has a table so that the user checks a page having a table on a preview screen.

14. The preview display apparatus according to claim 5,
wherein the evaluation-value acquisition unit acquires from each page as the evaluation value for the page an evaluation value relating to whether a background removal function has been applied to the page so that the user checks on a preview screen a page to which a background removal function has been applied.

15. A multifunction peripheral comprising:
the preview display apparatus according to claim 1.

16. An information processing apparatus comprising:
the preview display apparatus according to claim 1.

17. A preview display method comprising:
acquiring an evaluation value for each of a plurality of pages in accordance with a predetermined purpose, the plurality of pages being to be previewed;
adjusting a priority of each of the plurality of pages in accordance with the evaluation value for the page; and
displaying a preview image of each of the plurality of pages in accordance with the priority of the page adjusted by the adjusting of the priority of each of the plurality of pages.

18. A non-transitory computer-readable medium storing a preview display program causing a computer to function as the preview display apparatus according to claim 1.
